(19) United States
(12) Patent Application Publication
(10) Pub. No.: US 2025/0133270 A1
(43) Pub. Date: Apr. 24, 2025

(54) CONTENT SHARING PLATFORM

(71) Applicant: Hot Sake LLC, Roswell, GA (US)

(72) Inventors: Brian Edwards, Sandy Springs, GA (US); Michael Guris, Roswell, GA (US); Matthew Hunt, Atlanta, GA (US)

(73) Assignee: Hot Sake LLC, Roswell, GA (US)

(21) Appl. No.: 18/834,572

(22) PCT Filed: Jan. 30, 2023
(86) PCT No.: PCT/US2023/011894

§ 371 Date: Jul. 30, 2024

Related U.S. Application Data
(60) Provisional application No. 63/305,164, filed on Jan. 31, 2022.

(51) Int. Cl. H04N 21/482; G06F 40/30

(52) U.S. Cl. CPC H04N 21/4825; G06F 40/30

(57) ABSTRACT

Systems and methods for determining playback times for content items presented in playlists are disclosed. Techniques described herein include identifying a first content item in a content reel comprising a plurality of content items, and determining that the first content item has an undefined display duration. In response to the first content item having an undefined display duration, a display duration for which the first content item should be displayed when presented in the content reel is calculated. The content reel can be provided for display at a client device, such that the first content item is displayed for the display duration.

### CROSS-REFERENCE TO RELATED APPLICATIONS

This application claims the benefit of and priority to U.S. Provisional Patent Application No. 63/305,164, filed on Jan. 31, 2022, the contents of which are incorporated herein by reference in their entirety.

### BACKGROUND

Computer networks, such as the Internet, are used to share information and content, such as images, videos, and text information.

### SUMMARY

The systems and methods described herein provide improved sharing platforms for content, which can be accessed and utilized by multiple users over computer networks. For example, the systems and methods described herein can provide techniques for generating and sharing social content, which can include any type of content that is provided to and or accessible by a uniform resource identifier (URI) or other identifier (ID) and/or link. Users of the content sharing platforms described herein can save/store/link content, or identifiers of content, accessed from multiple sources to a common repository. The user, or the content sharing platform, can then arrange the content or content identifiers into playlists, which can be shared, modified, or otherwise accessed by other users of the content sharing platform.

In some implementations, users of the content sharing platform described herein can generate curated lists of content, such as a list of top-five items of content, using a mobile application executing on a client device. The curating user can then share their curated lists, or “reels,” of content with other users of the content sharing platform with which the curating user is associated. The lists of content generated using the application can be constructed from identifiers of content accessed from a number of different sources (e.g., media/content sites and/or platforms). When a list of content is accessed by a user of the content sharing platform, the content sharing platform can retrieve/request the content according to these identifiers, and present the content in the application in an order selected by list's creator.

At least one aspect of the present disclosure is directed to a method of determining playback times for content items presented in playlists. The method includes identifying a first content item in a content reel comprising a plurality of content items; determining that the first content item has an undefined display duration; calculating, in response to the first content item having an undefined display duration, a display duration for which the first content item should be displayed when presented in the content reel; and providing the content reel for display at a client device, such that the first content item is displayed for the display duration.

In some implementations, the display duration is calculated based at least on at least one of a format of the first content item or a size of the first content item. In some implementations, the first content item includes text, and wherein the display duration is calculated based at least on a length of the text or a complexity of the text. In some implementations, the method includes determining the complexity of the text included in the first content item using a trained semantic analysis model.

In some implementations, the first content item comprises an image, and calculating the display duration of the first content item comprises providing the image as input to a trained artificial intelligence model that generates the display duration as output. In some implementations, the first content item comprises a first content portion having a first modality and a second content portion having a second modality, and calculating the display duration of the first content item includes determining a first duration value based at least on the first content portion and a second duration value based at least on the second content portion; and calculating the display duration of the first content item based at least on the first duration value and the second duration value.

In some implementations, the method includes receiving a modification to the display duration of the first content item; and modifying the display duration of the first content item in the content reel according to the modification. In some implementations, the first content item of the content reel comprises an animated image or a video, and the method further includes determining a number of repetitions for the animated image or the video responsive to a duration of the animated image or the video being below a threshold. In some implementations, determining that the first content item has an undefined duration comprises extracting metadata from the first content item. In some implementations, identifying the first content item is responsive to receiving a request for the content reel from the client device.

At least one other aspect of the present disclosure is directed to a system for determining playback times for content items presented in playlists. The system includes one or more processors coupled to non-transitory memory. The system can identify a first content item in a content reel comprising a plurality of content items; determine that the first content item has an undefined display duration; calculate, in response to the first content item having an undefined display duration, a display duration for which the first content item should be displayed when presented in the content reel; and provide the content reel for display at a client device, such that the first content item is displayed for the display duration.

In some implementations, the display duration is calculated based at least on at least one of a format of the first content item or a size of the first content item. In some implementations, the first content item includes text, and wherein the display duration is calculated based at least on a length of the text or a complexity of the text. In some implementations, the system can determine the complexity of the text included in the first content item using a trained semantic analysis model.

In some implementations, the first content item comprises an image, and the system can calculate the display duration of the first content item by performing operations comprising providing the image as input to a trained artificial intelligence model that generates the display duration as output. In some implementations, the first content item comprises a first content portion having a first modality and a second content portion having a second modality, and the system can calculate the display duration of the first content item by performing operations comprising determining a first duration value based at least on the first content portion and a second duration value based at least on the second content portion; and calculating the display duration of the first content item based at least on the first duration value and the second duration value.

In some implementations, the system can receive a modification to the display duration of the first content item; and modify the display duration of the first content item in the content reel according to the modification. In some implementations, the first content item of the content reel comprises an animated image or a video, and the system can determine a number of repetitions for the animated image or the video responsive to a duration of the animated image or the video being below a threshold. In some implementations, the system can determine that the first content item has an undefined duration by performing operations comprising extracting metadata from the first content item. In some implementations, the system can identify the first content item responsive to receiving a request for the content reel from the client device.

At least one other aspect of the present disclosure is directed to a method of tracking and providing timestamps for chat feeds corresponding to content playback. The method includes receiving a message from a client device that indicates a reaction to a content item of a content reel; determining a relative timestamp for the reaction to the content item of the content reel displayed at the client device; storing the relative timestamp in association with an identifier of the reaction and the content reel; receiving, by the one or more processors, a request for the content reel from a second client device; and providing the content reel to the second client device for display, such that the reaction is displayed at the second client device according to the relative timestamp.

In some implementations, the reaction comprises an emoji. In some implementations, the method includes storing the reaction in association with the content item. In some implementations, the relative timestamp corresponds to an amount of time from a start time of the content reel. In some implementations, the relative timestamp corresponds to an amount of time from an initial display time of the content item in the content reel.

In some implementations, the reaction corresponds to a group, and wherein the method further includes determining that a user profile utilized by the second client device is associated with the group; and providing data corresponding to the reaction and the relative timestamp for display at the second client device responsive to determining that the user profile is associated with the group. In some implementations, the method includes receiving a request to associate the user profile utilized by the second client device to the group; and storing an indication that the user profile is associated with the group.

In some implementations, the method includes storing the reaction and the relative timestamp as part of a reaction chat in association with the group. In some implementations, the method includes receiving a second message from a third client device utilizing a second user profile of the group, the second message indicating a second reaction to the content reel; determining a second relative timestamp for the second reaction to the content reel displayed at the third client device; and storing the second reaction as part of the reaction chat in association with the second relative timestamp. In some implementations, the reaction comprises at least one of text data, an image, a video, or audio.

At least one other aspect of the present disclosure is directed to a system for tracking and providing timestamps for chat feeds corresponding to content playback. The system includes one or more processors coupled to non-transitory memory. The system can receive a message from a client device that indicates a reaction to a content item of a content reel; determine a relative timestamp for the reaction to the content item of the content reel displayed at the client device; store the relative timestamp in association with an identifier of the reaction and the content reel; receive a request for the content reel from a second client device; and provide the content reel to the second client device for display, such that the reaction is displayed at the second client device according to the relative timestamp.

In some implementations, the reaction comprises an emoji. In some implementations, the system can store the reaction in association with the content item. In some implementations, the relative timestamp corresponds to an amount of time from a start time of the content reel. In some implementations, the relative timestamp corresponds to an amount of time from an initial display time of the content item in the content reel.

In some implementations, the reaction corresponds to a group, and the system can determine that a user profile utilized by the second client device is associated with the group; and provide data corresponding to the reaction and the relative timestamp for display at the second client device responsive to determining that the user profile is associated with the group. In some implementations, the system can receive a request to associate the user profile utilized by the second client device to the group; and store an indication that the user profile is associated with the group.

In some implementations, the system can store the reaction and the relative timestamp as part of a reaction chat in association with the group. In some implementations, the system can receive a second message from a third client device utilizing a second user profile of the group, the second message indicating a second reaction to the content reel; determine a second relative timestamp for the second reaction to the content reel displayed at the third client device; and store the second reaction as part of the reaction chat in association with the second relative timestamp. In some implementations, the reaction comprises at least one of text data, an image, a video, or audio.

At least one other aspect of the present disclosure is directed to a method of managing messages transmitted between users. The method includes maintaining, for each user profile of a plurality of user profiles, an inbox that stores one or more messages identifying the user profile as a recipient; receiving, from a first client device, a request to transmit a first message comprising a content reel, the first message identifying a first user profile as a recipient; storing the first message in association with the inbox of the first user profile; receiving, from a second client device, a request to access the inbox of the first user profile; generating, by the one or more processors, a list of content reels corresponding to each message stored in association with the inbox of the first user profile, the list of content reels including the content reel of the first message; and providing the list of content reels for display in a user interface presented by the second client device.

In some implementations, the method includes generating a composite reel that includes content in each content reel of each message stored in association with the inbox of the first user profile. In some implementations, the first client device is associated with a second user profile, and the first message further identifies the second user profile as a sender. In some implementations, the method includes storing the first message in association with the first user profile and an indication that the second user profile is the sender of the first message. In some implementations, the inbox of the first user profile is stored in association with one or more threads that identify the first user profile.

In some implementations, the method includes providing a list of threads identifying the one or more threads for display by the second client device. In some implementations, a first thread of the one or more threads comprises a plurality of content reels, and the method includes generating a composite reel for the first thread comprising content from the plurality of content reels of the first thread.

In some implementations, a first thread of the one or more threads comprises a first chat message identifying the first user profile as a first sender, and a second chat message identifying a second user profile as a second sender. In some implementations, generating the list of content reels comprises sorting the list of content reels based on a timestamp associated with each content reel of the list of content reels. In some implementations, the method includes receiving a request to delete a message associated with the inbox of the first user profile; and removing an association between the inbox of the first user profile and the first message.

At least one other aspect of the present disclosure is directed to a system for managing messages transmitted between users. The system includes one or more processors coupled to non-transitory memory. The system can maintain, for each user profile of a plurality of user profiles, an inbox that stores one or more messages identifying the user profile as a recipient; receive, from a first client device, a request to transmit a first message comprising a content reel, the first message identifying a first user profile as a recipient; store the first message in association with the inbox of the first user profile; receive, from a second client device, a request to access the inbox of the first user profile; generate a list of content reels corresponding to each message stored in association with the inbox of the first user profile, the list of content reels including the content reel of the first message; and provide the list of content reels for display in a user interface presented by the second client device.

In some implementations, the system can generate a composite reel that includes content in each content reel of each message stored in association with the inbox of the first user profile. In some implementations, the first client device is associated with a second user profile, and the first message further identifies the second user profile as a sender. In some implementations, the system can store the first message in association with the first user profile and an indication that the second user profile is the sender of the first message. In some implementations, the inbox of the first user profile is stored in association with one or more threads that identify the first user profile.

In some implementations, the system can provide a list of threads identifying the one or more threads for display by the second client device. In some implementations, a first thread of the one or more threads comprises a plurality of content reels, and the system can generate a composite reel for the first thread comprising content from the plurality of content reels of the first thread. In some implementations, a first thread of the one or more threads comprises a first chat message identifying the first user profile as a first sender, and a second chat message identifying a second user profile as a second sender. In some implementations, the system can generate the list of content reels by performing operations comprising sorting the list of content reels based on a timestamp associated with each content reel of the list of content reels. In some implementations, the system can receiving a request to delete a message associated with the inbox of the first user profile; and removing an association between the inbox of the first user profile and the first message.

At least one other aspect of the present disclosure is directed to a method of tracking and tagging content. The method includes providing a content item for display by a client device in a user interface; receiving a selection of a tag for the content item from the client device in response to an interaction with a corresponding actionable object of the user interface; determining a timestamp for the tag that corresponds to a time at which the interaction was received; and storing an association between the tag, the timestamp, and the content item.

In some implementations, the method includes selecting a second content item for provision to the client device based at least on the association between the tag, the timestamp, and the content item. In some implementations, the method includes storing an association between the tag, a content reel that includes the content item, and a second relative timestamp corresponding to the content reel calculated based at least on the timestamp. In some implementations, the method includes selecting, based at least on the content item, a plurality of selectable tags for display in the user interface as actionable objects.

In some implementations, the method includes receiving a plurality of tags for the content item from a plurality of client devices, each tag of the plurality of tags associated with a respective timestamp. In some implementations, the method includes determining that a number of the plurality of tags that are associated with a common timestamp and a common tag type exceeds a threshold; and storing a sentiment corresponding to the common tag type in association the content item according to the common timestamp responsive to the number exceeding the threshold. In some implementations, the plurality of tags corresponds to a respective plurality of user profiles, and the method includes determining a respective reaction frequency of each of the plurality of user profiles; and storing the sentiment in association with the content item further based at least on the respective reaction frequency of each of the plurality of user profiles.

In some implementations, the method includes providing the content item to the client device as part of a chat message; and receiving the selection of the tag in a response message. In some implementations, the method includes receiving a request for content associated with the tag from a second client device; and selecting the content item for provision to the second client device based at least on the association between the tag, the timestamp, and the content item. In some implementations, the method includes receiving a request for a content reel that includes the content item; and selecting a plurality of content reels including the content item for provision to the client device.

At least one other aspect of the present disclosure is directed to a system. The system includes one or more processors coupled to non-transitory memory. The system can provide a content item for display by a client device in a user interface; receive a selection of a tag for the content item from the client device in response to an interaction with a corresponding actionable object of the user interface; determine a timestamp for the tag that corresponds to a time at which the interaction was received; and store an association between the tag, the timestamp, and the content item.

In some implementations, the system can select a second content item for provision to the client device based at least on the association between the tag, the timestamp, and the content item. In some implementations, the system can store an association between the tag, a content reel that includes the content item, and a second relative timestamp corresponding to the content reel calculated based at least on the timestamp. In some implementations, the system can select, based at least on the content item, a plurality of selectable tags for display in the user interface as actionable objects.

In some implementations, the system can receive a plurality of tags for the content item from a plurality of client devices, each tag of the plurality of tags associated with a respective timestamp. In some implementations, the system can determine that a number of the plurality of tags that are associated with a common timestamp and a common tag type exceeds a threshold; and store a sentiment corresponding to the common tag type in association the content item according to the common timestamp responsive to the number exceeding the threshold. In some implementations, the plurality of tags corresponds to a respective plurality of user profiles, and the system can determine a respective reaction frequency of each of the plurality of user profiles; and store the sentiment in association with the content item further based at least on the respective reaction frequency of each of the plurality of user profiles.

In some implementations, the system can provide the content item to the client device as part of a chat message; and receive the selection of the tag in a response message. In some implementations, the system can receive a request for content associated with the tag from a second client device; and select the content item for provision to the second client device based at least on the association between the tag, the timestamp, and the content item. In some implementations, the system can receive a request for a content reel that includes the content item; and select a plurality of content reels including the content item for provision to the client device.

At least one other aspect of the present disclosure is directed to a method of content modification. The method includes presenting a content item of a first content reel in a user interface that includes a plurality of actionable objects that each correspond to a respective modification operation; detecting selection of an actionable object of the plurality of actionable objects; modifying the content item according to a respective modification operation corresponding to the actionable object; presenting the modified content item in the user interface; and transmitting the modified content item to one or more servers in a request to store a second content reel.

In some implementations, the method includes presenting the first content reel including the content item in a second user interface; and presenting the content item in the user interface for modification in response to an interaction with the second user interface. In some implementations, the respective modification operation comprises addition of a text overlay on the content item. In some implementations, the method includes receiving input specifying one or more of a size, a font, or a position of the text overlay; and modifying the content item to include the text overlay according to the size, the font, or the position specified via the input.

In some implementations, the content item is a video, and the method includes receiving input specifying a set of frames of the video to display the text overlay; and modifying the video to include the text overlay on the set of frames. In some implementations, modifying the content item includes storing the text overlay on a separate layer displayed over the content item; and generating the modified content item based at least on the content item and pixels of the separate layer. In some implementations, the method includes presenting a video on a display device; and generating the content item by capturing a screenshot of the display device and extracting pixels corresponding to a frame of the video from the screenshot.

In some implementations, the second content reel is associated with a user profile, and the method includes transmitting the modified content item to the one or more servers, causing the one or more servers to store the modified content item in association with the user profile. In some implementations, the method includes applying one or more filters to the content item in response to an interaction with a second actionable object of the plurality of actionable objects. In some implementations, the respective modification operation includes at least one of pruning content, overlaying images, or inserting the content item into a predetermined layout.

At least one other aspect of the present disclosure is directed to a system for content modification. The system includes one or more processors coupled to non-transitory memory. The system can present a content item of a first content reel in a user interface that includes a plurality of actionable objects that each correspond to a respective modification operation; detect selection of an actionable object of the plurality of actionable objects; modify the content item according to a respective modification operation corresponding to the actionable object; present the modified content item in the user interface; and transmit the modified content item to one or more servers in a request to store a second content reel.

In some implementations, the system can present the first content reel including the content item in a second user interface; and present the content item in the user interface for modification in response to an interaction with the second user interface. In some implementations, the respective modification operation comprises addition of a text overlay on the content item. In some implementations, the system can receive input specifying one or more of a size, a font, or a position of the text overlay; and modify the content item to include the text overlay according to the size, the font, or the position specified via the input.

In some implementations, the content item is a video, and the system can receive input specifying a set of frames of the video to display the text overlay; and modify the video to include the text overlay on the set of frames. In some implementations, the system can modify the content item by performing operations comprising storing the text overlay on a separate layer displayed over the content item; and generating the modified content item based at least on the content item and pixels of the separate layer. In some implementations, the system can present a video on a display device; and generate the content item by capturing a screenshot of the display device and extracting pixels corresponding to a frame of the video from the screenshot.

In some implementations, the second content reel is associated with a user profile, and the system can transmit the modified content item to the one or more servers, causing the one or more servers to store the modified content item in association with the user profile. In some implementations, the system can apply one or more filters to the content item in response to an interaction with a second actionable object of the plurality of actionable objects. In some implementations, the respective modification operation comprises at least one of pruning content, overlaying images, or inserting the content item into a predetermined layout.

At least one other aspect of the present disclosure is directed to a method of dynamic generation of content reels. The method includes receiving a request for content from a client device associated with a user profile, the request comprising a duration for the content; selecting a subset of content items from a plurality of content items based at least on one or more attributes of the user profile, the subset of content items collectively satisfying the duration; generating a content reel that includes the subset of content items; and transmitting the content reel to the client device in response to the request.

In some implementations, the request specifies at least one source of content. In some implementations, the at least one source of content comprises a set of content items associated with the user profile. In some implementations, the plurality of content items are not associated with the user profile, and the subset of content items are selected from the set of content items associated with the user profile and the plurality of content items. In some implementations, the request comprises at least one exclusion criteria, and the subset of content items are selected from the plurality of content items further based at least on the at least one exclusion criteria.

In some implementations, the subset of content items are selected further based at least on one or more attributes of previously accessed content reels stored in association with the user profile. In some implementations, the subset of content items are selected further based on one or more attributes of content items previously included in content reels generated using the user profile. In some implementations, the method includes storing an association between the user profile and the content reel.

In some implementations, the method includes receiving a request to share the content reel in connection with a second user profile; and storing an association between the second user profile and the content reel. In some implementations, the method includes selecting a set of content items for inclusion in the content that each identifies a common user profile as a creator.

At least one other aspect of the present disclosure is directed to a system for dynamic generation of content reels. The system includes one or more processors coupled to non-transitory memory. The system can receive a request for content from a client device associated with a user profile, the request comprising a duration for the content; select a subset of content items from a plurality of content items based at least on one or more attributes of the user profile, the subset of content items collectively satisfying the duration; generate a content reel that includes the subset of content items; and transmit the content reel to the client device in response to the request.

In some implementations, the request specifies at least one source of content. In some implementations, the at least one source of content comprises a set of content items associated with the user profile. In some implementations, the plurality of content items are not associated with the user profile, and the subset of content items are selected from the set of content items associated with the user profile and the plurality of content items. In some implementations, the request comprises at least one exclusion criteria, and the subset of content items are selected from the plurality of content items further based at least on the at least one exclusion criteria.

In some implementations, the subset of content items are selected further based at least on one or more attributes of previously accessed content reels stored in association with the user profile. In some implementations, the subset of content items are selected further based on one or more attributes of content items previously included in content reels generated using the user profile. In some implementations, the system can store an association between the user profile and the content reel. In some implementations, the system can receive a request to share the content reel in connection with a second user profile; and store an association between the second user profile and the content reel. In some implementations, the system can select a set of content items for inclusion in the content that each identifies a common user profile as a creator.

At least one aspect of the present disclosure is directed to determining playback times for content items presented as part of a playlist. The system can identify a first content item in a content reel (e.g., a content playlist, etc., which may be presented or listed in a thumbnail/visual format/sequence/reel) including multiple content items. The system can determine that the first content item does not have a defined display duration. The system can calculate/determine a duration that the first content item should be displayed within the content reel based on attributes of the content item, such as text length, text complexity, content item size, or content item format, among others. The content item duration can be stored in association with an identifier of the content item, for example, as part of the content reel. When the content reel is presented at a client device, the content reel can present the first content item for the calculated duration, before transitioning to another content item in the content reel.

At least one other aspect of the present disclosure is directed to tracking and providing timestamps for chat feeds (e.g., reaction chats, or side chats with a private group of users) that correspond to content playback. The system can receive messages from client devices that correspond to reactions or responses to portions of the content. The messages can include a relative timestamp of the playback of the content item at the time the client device provided/entered/registered the message to the system. The system can store/maintain/record both the reaction and the relative timestamp in association with an identifier of the displayed content item, for example, as part of a chat (or reaction/response) feed. When the corresponding content item is displayed to other client devices, the system can provide the reactions to the content in a chat feed displayed in connection with the content item according to the relative timestamps.

At least one other aspect of the present disclosure is directed to the management of messages transmitted between users of the content sharing platform. The system can maintain an inbox for each user that can store and/or visually present/list/organize (e.g. unread) content and/or messages received from other users (e.g. different users or groups of users), for instance streamlined into a single reel. The system can provide user interfaces to allow users to construct messages that include (e.g., to share or recommend) one or more content items or one or more playlists of content, which may include reactions, comments, or other messages at relative timestamps. Once the message is constructed, the user can designate one or more recipients for the message via the user interfaces. The system can store an association between the message and the recipients, such that the recipients of the message can access the message to display the reel(s) of content included therein.

At least one other aspect of the present disclosure is directed to tracking and tagging content with one or more tags that identify, for example, predetermined sentiments. The system can provide a content item for display at a client device via a user interface. The user interface can include a set of predetermined sentiments, which the user can select to assign a corresponding tag to the content. The application executing at the client device can identify a timestamp, or a portion of the content, that one or more selected sentiments are to be assigned. The system can then store an association between the selected sentiments, the timestamp and/or portion of content. The system can select personalized content/advertising to serve to the client device based on the selected sentiments.

At least one other aspect of the present disclosure is directed to a content modification (e.g., meme creation) platform integrated with a client device. An application executing on the client device can access content provided by a content sharing platform, for example, as part of a playlist or reel. The application can present the content in a content modification interface, which can include buttons, links, or other actionable objects that allow for a user to interact with and modify the content. The application can receive a selection from the user via the user interface to modify the content item. The application can generate a modified content item based on the user selection, and can transmit the content item to the content sharing platform. The content sharing platform can store an association between a profile of the user and the modified content item, and may allow the user to include the modified content item in one or more playlists or messages, save the image or video locally, or share it externally (via email, SMS, or other messaging)

At least one other aspect of the present disclosure is directed to dynamic generation of content playlists, or reels. The system can receive a request for content from a client device that identifies/specifies a duration for a content playlist. The client device may access the functionality of the system based on a user profile. The system can generate/build a playlist that has a total duration that is less than or equal to the duration identified in the request. The system can select content items for inclusion in the playlist based on attributes of the user profile identified in the request for content. Upon generating the playlist, the system can transmit the playlist, which can include a list of identifiers of content items in the playlist, to an application executing on the client device. The application can then present the playlist of content items in a user interface.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. Aspects can be combined and it will be readily appreciated that features described in the context of one aspect of the invention can be combined with other aspects. Aspects can be implemented in any convenient form. For example, by appropriate computer programs, which may be carried on appropriate carrier media (computer readable media), which may be tangible carrier media (e.g. disks) or intangible carrier media (e.g. communications signals). Aspects may also be implemented using suitable apparatus, which may take the form of programmable computers running computer programs arranged to implement the aspect. As used in the specification and in the claims, the singular form of ‘a’, ‘an’, and ‘the’ include plural referents unless the context clearly dictates otherwise.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is a block diagram of an example system for a content sharing platform including a content server and client devices, in accordance with one or more implementations;

FIGS. 2A, 2B, 2C, 2D, 2E, 2F, 2G, 2H, 2I, 2J, and 2K illustrate example user interfaces of applications executing on client devices that interact with the content sharing platforms described herein, in accordance with one or more implementations;

FIG. 3A is a block diagram depicting an embodiment of a network environment comprising a client device in communication with a server device;

FIG. 3B is a block diagram depicting a cloud computing environment comprising a client device in communication with cloud service providers; and

FIGS. 3C and 3D are block diagrams depicting embodiments of computing devices useful in connection with the methods and systems described herein.

### DETAILED DESCRIPTION

Below are detailed descriptions of various concepts related to, and implementations of, techniques, approaches, methods, apparatuses, and systems for content sharing platforms. The various concepts introduced above and discussed in greater detail below may be implemented in any of numerous ways, as the described concepts are not limited to any particular manner of implementation. Examples of specific implementations and applications are provided primarily for illustrative purposes.

For purposes of reading the description of the various implementations below, the following descriptions of the sections of the Specification and their respective contents may be helpful:
Section A describes a system architecture overview for the content sharing platform techniques described herein;
Section B describes techniques for calculating playback times for content in content playlists;
Section C describes techniques for tracking and annotating chat interfaces for multiple users;
Section D describes techniques for managing messages and inboxes that present reels of content;
Section E describes techniques for tracking and tagging content with predefined sentiments for use in analysis;
Section F describes techniques for integrated content modification and publishing;
Section G describes techniques for dynamic generation of content playlists for users; and
Section H describes a network environment and computing environment which may be useful for practicing embodiments described herein.

### A. Content Sharing Platform Architectural Overview

The systems and methods of this technical solution provide techniques for implementing a content sharing platform. The content sharing platform can be accessed by a number of users, for example, via user profiles. The content sharing platform can provide reels of content, which are content playlists with a predetermined duration, which present curated content to users according to the duration of each content item in the playlist. Users of the content sharing platform can share content items and content playlists (sometimes referred to herein as “content reels” or “reel(s)”) with other users. The content sharing platform can further enable users to interact with content items in the content reels, and provide messages, reactions, or sentiment associations, which can be used to provide customized or personalized content to the users of the content sharing platform.

The content sharing platform can be accessed, for example, using an application executing on a client device, which can be a smartphone, a laptop, a personal computer, or any other computing device described herein. As described in greater detail herein, the application used to interact with the content sharing platform can enable a user to transmit messages, engage in social relationships with other users, and interact with content in an improved technical environment. The application can allow users to save content (e.g., tweet, post, image, video, audio, multimedia) of various/different formats and/or from multiple/different external sources into a single private repository corresponding to that user. The user can then utilize the application to access this saved content at a later time, according to their preferences, in a single unified viewing experience. Users can also curate public personal lists of content, such as a “Top-5” list of content items, which can be shared with other users of the content sharing platform. Users can discover content by accessing public playlists curated by other users.

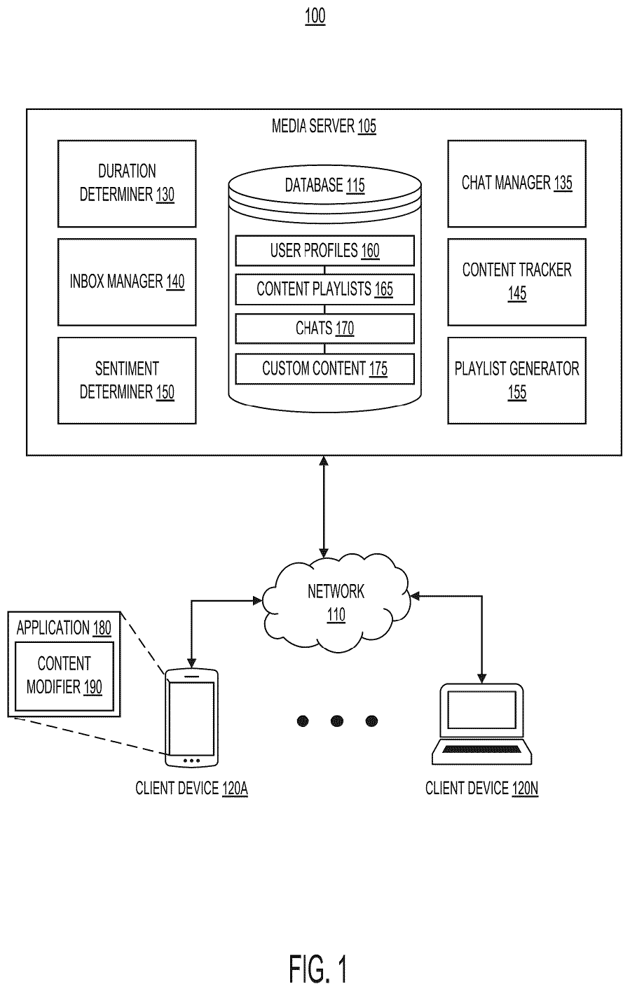

An example system architecture of a content sharing platform is depicted in FIG. 1. Referring now to FIG. 1, illustrated is a block diagram of an example system 100 for a content sharing platform including a media server 105 and client devices 120A-120N (sometimes generally referred to as “client device(s) 120”). The system 100 can include at least one media server 105, at least one network 110, and one or more client devices 120. The media server 105 can include at least one duration determiner 130, at least one chat manager 135, at least one inbox manager 140, at least one content tracker 145, at least one sentiment determiner 150, at least one playlist generator 155, and at least one database 115. The database 115 can include one or more user profiles 160, one or more content playlists 165, one or more chats 170, and custom content items 175 (sometimes generally referred to herein as “custom content 175”). In some implementations, the database 115 can be external to the media server 105, for example, as a part of a cloud computing system or an external computing device in communication with the devices (e.g., the media server 105, the client devices 120, etc.) of the system 100 via the network 110. The client devices 120 can each execute an application 180, which can include a content modifier 190.

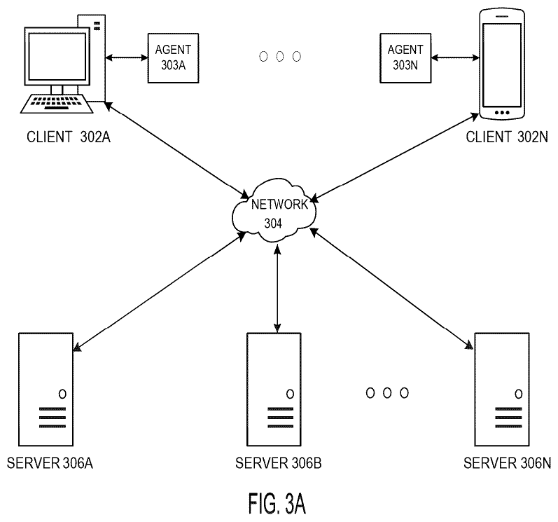

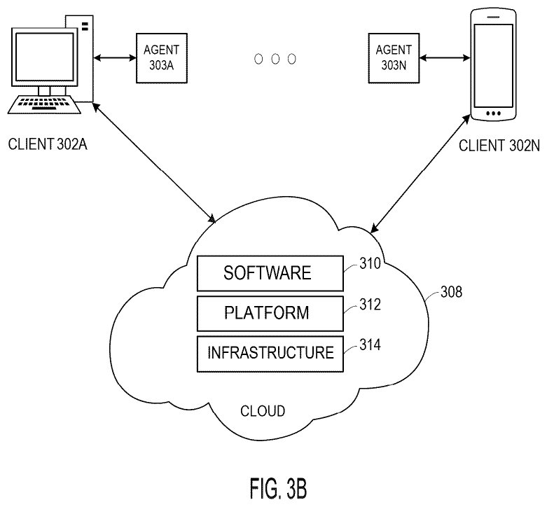

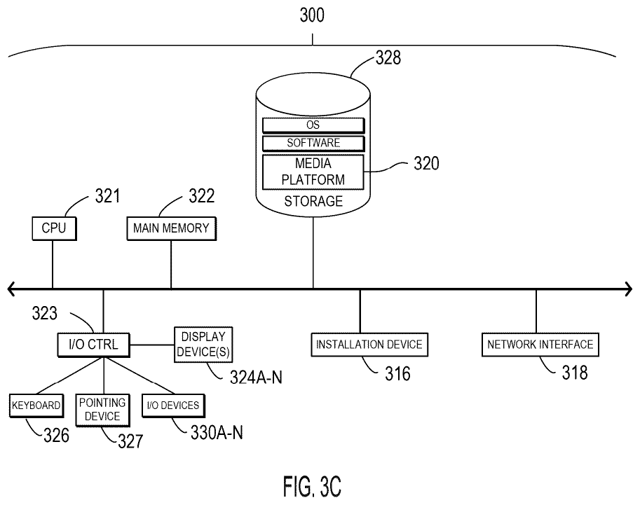

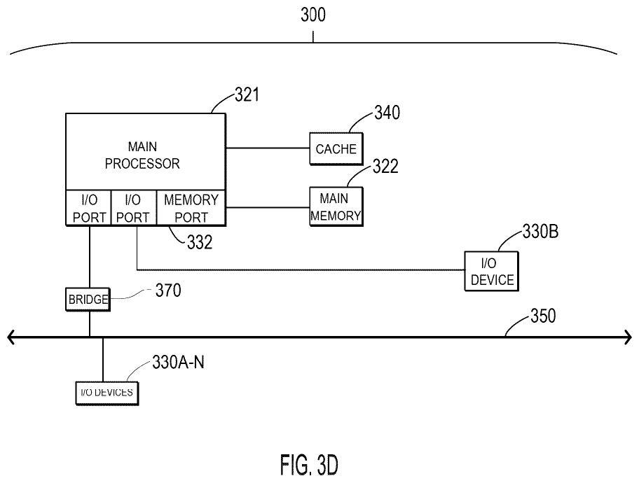

Each of the components (e.g., the media server 105, the network 110, the client devices 120, the duration determiner 130, the chat manager 135, the inbox manager 140, the content tracker 145, the sentiment determiner 150, the playlist generator 155, the database 115, the application 180, the content modifier 190, etc.) of the system 100 can be implemented using the hardware components or a combination of software with the hardware components of a computing system, such as the computing system 300 detailed herein in connection with FIGS. 3A-3D, or any other computing system described herein. Each of the components of the media server 105 can perform the functionalities detailed herein. The functionality of the duration determiner 130, the chat manager 135, the inbox manager 140, the content tracker 145, the sentiment determiner 150, the playlist generator 155, and the content modifier 190 are described in greater detail in connection with Sections B-G.

The media server 105 can include at least one processor and a memory (e.g., a processing circuit). The memory can store processor-executable instructions that, when executed by the processor, cause the processor to perform one or more of the operations described herein. The processor may include a microprocessor, an application-specific integrated circuit (ASIC), a field-programmable gate array (FPGA), a graphics processing unit (GPU), or combinations thereof. The memory may include, but is not limited to, electronic, optical, magnetic, or any other storage or transmission device capable of providing the processor with program instructions. The memory may further include a floppy disk, CD-ROM, DVD, magnetic disk, memory chip, ASIC, FPGA, read-only memory (ROM), random-access memory (RAM), electrically erasable programmable ROM (EEPROM), erasable programmable ROM (EPROM), flash memory, optical media, or any other suitable memory from which the processor can read instructions. The instructions may include code from any suitable computer programming language. The media server 105 can include one or more computing devices or servers that can perform various functions as described herein. The media server 105 can include any or all of the components and perform any or all of the functions of the computer system 300 described herein in conjunction with FIGS. 3A-3D. The media server 105 can be, or can be similar to, the servers 306 described in connection with FIGS. 3A-3D.

The network 110 can include computer networks such as the Internet, local, wide, metro or other area networks, intranets, satellite networks, other computer networks such as voice or data mobile phone communication networks, and combinations thereof. The media server 105 of the system 100 can communicate via the network 110, for instance with one or more client devices 120. The network 110 may be any form of computer network that can relay information between the media server 105, the one or more client devices 120, and one or more information sources (not pictured), which can include web servers, social media platforms, external databases, or other content sources, amongst others. In some implementations, the network 110 may include the Internet and/or other types of data networks, such as a local area network (LAN), a wide area network (WAN), a cellular network, a satellite network, or other types of data networks. The network 110 may also include any number of computing devices (e.g., computers, servers, routers, network switches, etc.) that are configured to receive and/or transmit data within the network 110. The network 110 may further include any number of hardwired and/or wireless connections. Any or all of the computing devices described herein (e.g., the media server 105, the one or more client devices 120, the computing system 300, etc.) may communicate wirelessly (e.g., via Wi-Fi, cellular, radio, etc.) with a transceiver that is hardwired (e.g., via a fiber optic cable, a CAT5 cable, etc.) to other computing devices in the network 110. Any or all of the computing devices described herein (e.g., the media server 105, the one or more client devices 120, the computer system 300, etc.) may also communicate wirelessly with the computing devices of the network 110 via a proxy device (e.g., a router, network switch, or gateway). In some implementations, the network 110 can be similar to or can include the network 304 or the cloud 308 described in connection with FIGS. 3A and 3B.

Each of the client devices 120 can include at least one processor and a memory device (e.g., a processing circuit). The memory can store processor-executable instructions that, when executed by the processor, cause the processor to perform one or more of the operations described herein. The processor can include a microprocessor, an ASIC, an FPGA, a GPU, or combinations thereof. The memory can include, but is not limited to, electronic, optical, magnetic, or any other storage or transmission device capable of providing the processor with program instructions. The memory can further include a floppy disk, CD-ROM, DVD, magnetic disk, memory chip, ASIC, FPGA, ROM, RAM, EEPROM, EPROM, flash memory, optical media, or any other suitable memory from which the processor can read instructions. The instructions can include code from any suitable computer programming language. The client devices 120 can include one or more computing devices that can perform various functions as described herein. The one or more client devices 120 can include any or all of the components and perform any or all of the functions of the computer system 300 described in connection with FIGS. 3A-3D. The client devices 120 can be, or can be similar to, the client devices 302 described in connection with FIGS. 3A-3D.

Each client device 120 can include, but is not limited to, a smart phone, a laptop, a personal computing device, a mobile device, or another type of computing device. The functionality of each client device 120 as described herein can be implemented using hardware or a combination of software and hardware. Each client device 120 can include a display or display portion. The display can include an interactive display (e.g., a touchscreen, a display, etc.), and one or more input/output (I/O) devices (e.g., a touchscreen, a mouse, a keyboard, digital key pad). The display can include a touch screen displaying an application 180, described in further detail herein. The display can include a border region (e.g., side border, top border, bottom border). In some implementations, the display can include a touch screen display, which can receive interactions from a user. The interactions can cause the client device to generate interaction data, which can be stored and transmitted by the processing circuitry of the client device 120. The interaction data can include, for example, interaction coordinates, an interaction type (e.g., click, swipe, scroll, tap, etc.), and an indication of an actionable object (e.g., a button, a link, a user interface element, etc.) with which the interaction occurred. Each client device 120 can include an input device that couples or communicates with the client device 120 to enable a user to interact with and/or select one or more actionable objects (e.g., presented as part of the application 180, etc.) as described herein.

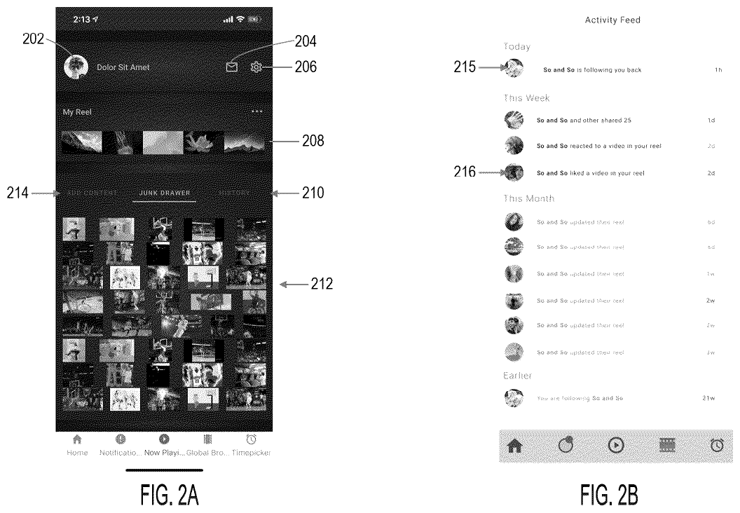

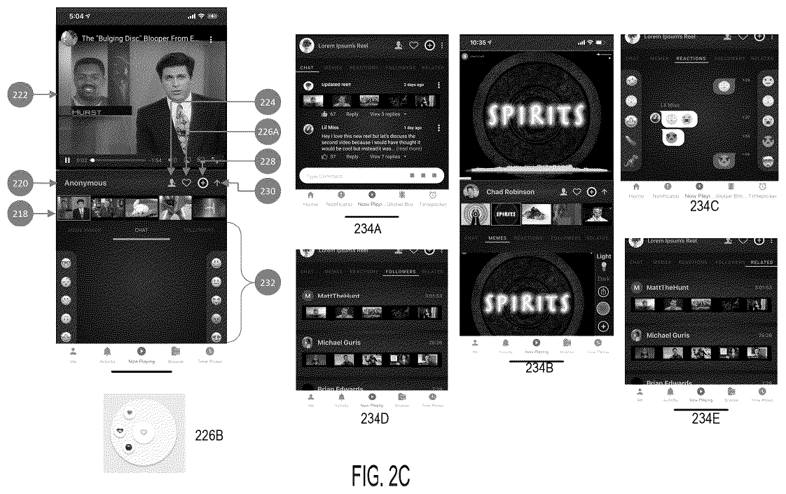

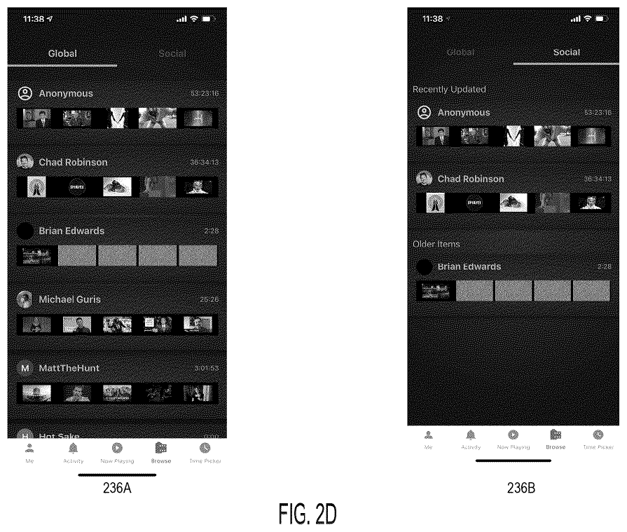

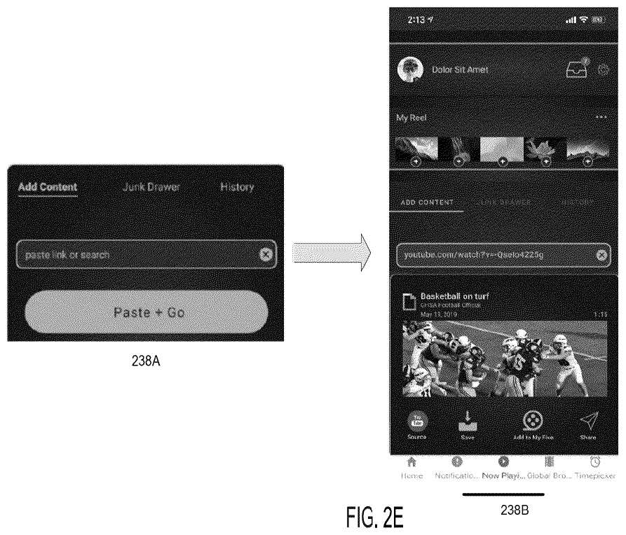

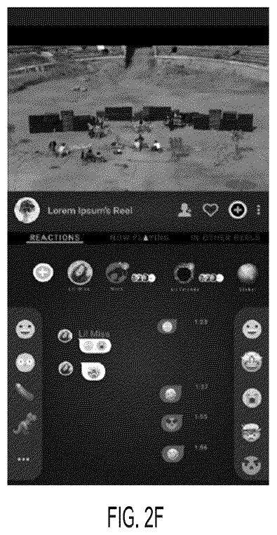

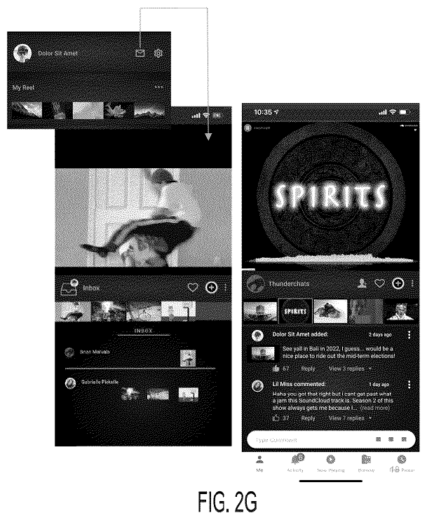

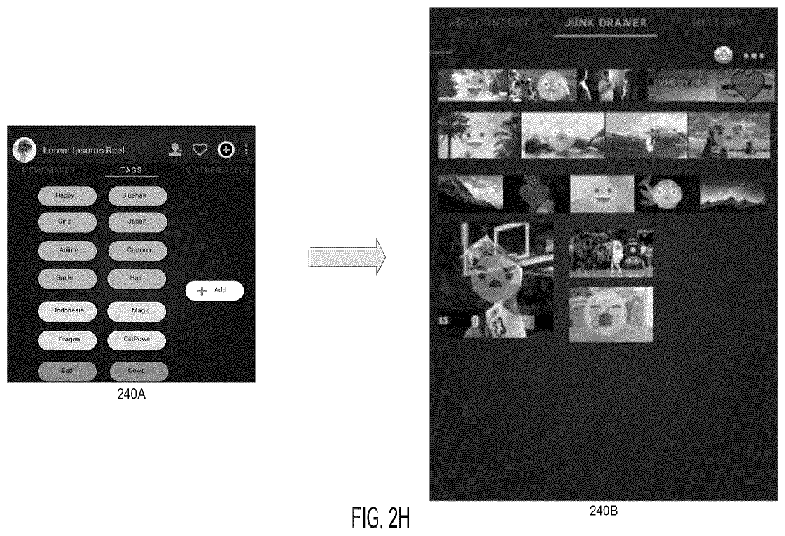

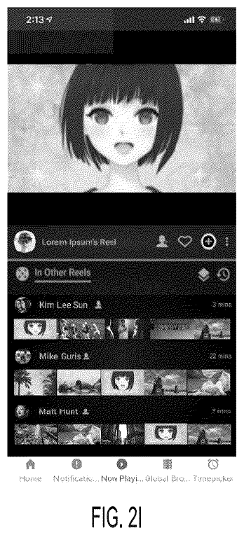

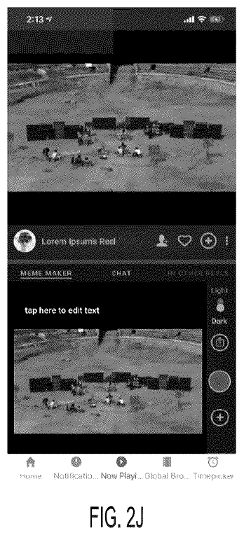

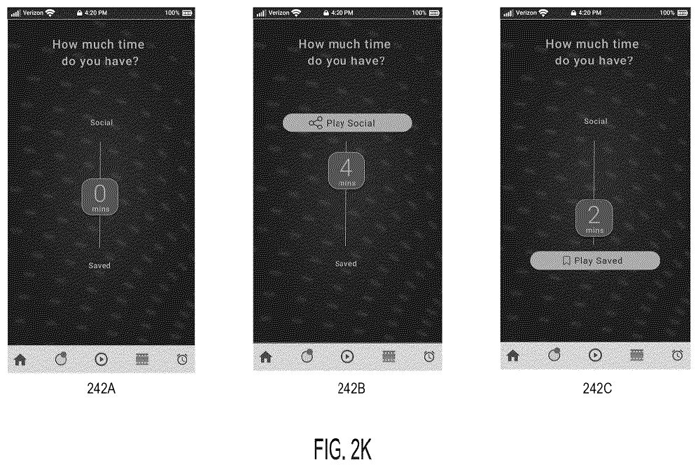

Each client device 120 can include a device identifier, which can be specific to each respective client device 120. The device identifier can include a script, code, label, or marker that identifies a particular client device 120. In some implementations, the device identifier can include a string or plurality of numbers, letters, characters or any combination of numbers, letters, and characters. In some embodiments, each client device 120 can have a unique device identifier. Each client device 120 can execute an application 180, which can be a social media application, which is used to communicate with the media server 105 to access and share content. The application 180 can be provided to the client device 120, for example, by the media server 105 or another external server via the network 110. The application 180 can be, for example, a web-based application, a software-as-a-service application, a native or local application, or a virtual application, among others. In some implementations, the application 180 can access one or more of the user profiles 160, the content playlists 165, the chats 170, or the custom content 175, stored and maintained at the database 115. The application 180 can present one or more actionable objects in user interfaces to carry out the functionality described herein. Some examples of such user interfaces are depicted in FIGS. 2A-2K and described in greater detail herein. Actionable objects presented in the application 180 can include user-selectable hyperlinks, buttons, graphics, videos, images, or other user interface elements that cause the application 180 to generate interaction data, which may be processed by the application 180 or transmitted to the media server 105.

The application 180 executing on the client devices 120 can establish one or more communication sessions with the media server 105, for example, using identifiers of a user profile 160. For example, the application 180 can log in to the media server 105 using a username, a password, other types of identifiers of a user profile 160, to identify the user that is interacting with the media server 105 during the one or more communication sessions. The one or more communication sessions can each include a channel or connection between the media server 105 and the one or more client devices 120. Each communication session can include encrypted and/or secure sessions, which can include an encrypted file, encrypted data or traffic.

The client devices 120 can be computing devices that can communicate via the network 110 to access information resources, such as web pages via a web browser, content items, or application resources via native applications executing on a client device 120. When accessing information resources or content items, the client device 120 can execute instructions (e.g., embedded in the native applications, in the information resources, etc.) that cause the client devices to display a user interface that includes the content items, such as the user interfaces described herein below in connection with FIGS. 2A-2K. The user interfaces can be, for example, user interfaces that provide various social media network functionalities, including accessing content, annotating or tagging content with predefined sentiments, sending messages or chats 170 to other users, modifying or creating custom content items 175, and other functionality as described in greater detail herein. A user can interact with the user interface elements described herein to provide selections or other interactions to carry out the various operations of the media sharing platform. The application 180 can include a content modifier 190 (e.g., meme making/creating tool and/or interface), which can be used to create or modify custom content 175. The functionality of the content modifier 190, and its corresponding interactions with the media server 105, is described in greater detail in connection with Section F.

The database 115 can be a computer-readable memory that can store or maintain any of the information described herein. The database 115 can maintain one or more data structures, which may contain, index, or otherwise store each of the values, sets, variables, vectors, numbers, or thresholds described herein. The database 115 can be accessed using one or more memory addresses, index values, or identifiers of any memory object, data structure, or memory region maintained in the database 115. The database 115 can be accessed by the components of the media server 105, or any other computing device described herein, via the network 110. In some implementations, the database 115 can be internal to the media server 105. In some implementations, the database 115 can be external to the media server 105, and may be accessed via the network 110. The database 115 can be distributed across many different computer systems or storage elements, and may be accessed via the network 110 or a suitable computer bus interface.

The media server 105 can store, in one or more regions of the memory of the media server 105, or in the database 115, the results of any or all computations, determinations, selections, identifications, or calculations in one or more data structures indexed or identified with appropriate values. Any or all values stored in the database 115 may be accessed by any computing device described herein, such as the media server 105, to perform any of the functionalities or functions described herein. In some implementations, the database 115 can be similar to or include the storage 328 described herein above in conjunction with FIG. 3C. In such implementations, the database 115 can be a distributed storage medium in a cloud computing system 308, and can be accessed by any of the components of the media server 105, by the one or more client devices 120 (e.g., via user interfaces similar those depicted in FIGS. 2A-2K, etc.), or any other computing devices described herein. In some implementations, a computing device must be authorized to access the information stored in the database 115 (e.g., the user profiles 160, the content playlists 165, the chats 170, the custom content 175, other values, etc.). For example, a client device 120 may access content playlists 165, chats 170, and custom content 175 that is associated with, or shared with, a user profile 160 used to access the media server 105. The client device 120 may not be able to access information that is not public and/or not associated with that user profile 160.

The database 115 can store one or more user profiles 160, which can each be associated with and can identify a corresponding user. Users can access the functionality of the media server 105 by providing identifiers of a user profile 160, which can include login information such as a username, a password, an e-mail address, a phone number, a personal identification number (PIN), a secret code-word, or device identifiers for use in a two-factor authentication technique, among others. The user profile 160 can be an account of the media server 105 that includes information about a corresponding user (e.g., user information, associated content, associated content playlists 165, associated chats 170, associated custom content 175, other associated information as described herein, etc.) and information about one or more of the client devices 120 used to access the media server 105 using the user profile 160. For example, identifiers of a user profile 160 can be used to access the functionality and/or content of the media server 105. The user profile 160 can store information about accessed content items, accessed content playlists 165, messages in chats 170, generate custom content 175, other messages transmitted using the user profile 160, reaction emojis, predefined sentiments assigned to content items using the user profile 160, interactions between the client device 120 and the media server 105, or other content-related information as described herein.

The user profiles 160 can store a list of other associated user profiles 160, which can be identified as “followers,” if the user profile 160 is identified as following another user profile 160, “friends” of the user profile 160, if the user profile 160 and the other user profile 160 mutually follow each other. The follower or friend associations stored between the user profiles 160 can form a graph data structure (sometimes referred to as a “follower graph”), where each node in the graph is a user profile 160, and each edge in the graph can reflect a relationship between two user profiles 160. The graph data structures can be maintained, modified, and updated in the database 115 by the media server 105. User profiles 160 can create follower relationships with other user profiles 160 by transmitting follow requests identifying other user profiles 160 to the media server 105. If another user accessing the media server 105 via the other identified user profile 160 mutually follows the user profile 160 that transmitted the follow request, the media server 105 can create a friend association between the two user profiles 160 in the friend graph. Otherwise, the media server 105 can create a one-way follow relationship, indicating that the user profile 160 that was used to transmit the follow request is following the other user profile 160 identified in the request. The user profiles 160 can store information about a client device 120 used to access the media server 105, such as an IP address, a MAC address, a globally unique identifier (GUID), an user profile name (e.g., the name of a user of the client device 120, etc.), or a device name, among others. In some implementations, a user profile 160 can be created by the media server 105 in response to a user profile creation request transmitted by a client device 120. The user profile creation request can include any of the user profile information described herein. Users can update information in their user profiles 160 by transmitting corresponding messages to the media server 105 that identifies the requested update to their user profile 160.

The database 115 can store or maintain one or more content playlists 165, which can be associated with one or more user profiles 160. A content playlist 165 can be a list of identifiers of content items (e.g., text, images, videos, audio, combinations thereof, etc.). In some implementations, content items can include social media information, such as social media posts (e.g., Tweets, Instagram posts, Facebook posts, etc.). The identifiers of the content items in a content playlist 165 can be, for example, uniform resource identifiers (URI) that identify a location of the respective content item. In some implementations, one or more of the content items in a content playlist 165 may be stored at computing devices, servers, or databases that are external to the media server 105. When a client device 120 accesses a content playlist 165 for display, the application 180 executing on the client device 120 may transmit a request for the content via the network 110 using the URI. In some implementations, a content playlist 165 may include pre-caching instructions that indicate to a client device 120 to request multiple content items in the content playlist 165 prior to displaying the items in the content playlist 165. In some implementations, a content playlist 165 can include a predetermined number of content items. In some implementations, the content items in a content playlist 165 can be displayed in a predetermined order, which can be stored as part of the content playlist 165. Content items in a content playlist 165 can be displayed for a predetermined duration. For example, video content often has a predetermined length.

A content item in a content playlist 165 can be stored in association with the duration of the item of content, such that the content item is displayed for the predetermined duration before the next content item in the content playlist 165 is seamlessly displayed. In some implementations, a content item in a content playlist 165 can be associated with a predetermined time window. For example, a video may be a certain number of minutes long, while the content playlist 165 may identify a segment (e.g., a start time, a duration, an end time, etc.) of the video file to display as part of the content playlist. Similar segments can be stored or identified for other temporal content, such as audio content. Some content, such as text content, may not include temporal elements, and thus may be assigned a duration according to the techniques described herein in connection with Section B. In some implementations, content that does not have a duration (e.g., text-based social media posts, other text-based content, etc.) may be displayed as part of the content playlist 165 until an interaction occurs at a client device 120 or until the assigned duration is reached, after which the next item of content in the content playlist 165 is displayed.

The content playlists 165 may be stored in association with one or more chats 170, which are described in greater detail herein. In some implementations, custom content 175 may be included in one or more content playlists 165. As described herein, users accessing the media server 105 can utilize the application 180 executing on a respective client device 120 to create content playlists 165 associated with their user profile 160. The content playlists 165 (or identifiers of the content playlists) can be shared with other users via the media server 105. In addition, and as described in greater detail in connection with Section G, content playlists 165 can be dynamically generated based on requests received from users. Content items and content playlists 165 can be stored in association with one or more reactions or with one or more predefined sentiments, which can be inferred from reaction messages or assigned via user input.

The database 115 can store or maintain one or more chats 170, for example, in one or more data structures. The chats 170 can be, for example, reaction chats, where users can assign reaction images, such as emojis, icons, text, content items, or other reaction messages, to relative timestamps in content items. For example, as video content plays (e.g., when accessing a content playlist 165, etc.), users may access a user interface provided by the application 180 that provides reaction images. In response to an interaction, the application can transmit/post a message to the media server 105 that includes a message and a relative timestamp of the content item to which the message corresponds (e.g., allowing a user to react/post to a specific time period/instance in a content item). In some implementations, the message can identify a chatroom or group of user profiles 160 that can access the message. In some implementations, the message can be identified as a public chat 170, such that any user of the media server 105 can view the information in the message once assigned to a particular content item, content playlist 165, or social media interaction (e.g., a reply to a post, etc.). Chats 170 that are associated with a predetermined group of user profiles 160 (e.g., sometimes referred to herein as “side chats 170”) can be associated with any number of content items or content playlists 165, and particular reactions in a side chat 170 can be displayed in connection with associated content when accessed by a user profile 160 that is a member of the side chat 170. The media server 105 may access one or more of the chats 170 to identify segments of content or content playlists 165 that correspond to identified segments, which may be useful in recommending content to other users that access the media server 105.

The database 115 can store or maintain one or more custom content items 175, for example, in one or more data structures. As described in greater detail in connection with Section F, the application 180 can include a content modifier 190 that can create modified copies of content items accessed via the media server 105. These modified content items may be referred to herein as “custom content 175” or “custom content items 175,” and can be stored in association with a respective user profile 160 used to modify or create the custom content 175. Users accessing the media server 105 using a corresponding user profile 160 can include custom content 175 in one or more content playlists 165. In some implementations, custom content 175 can include overlays, such as text information, image information, and any corresponding formatting information that indicates the overlay should be shown over an identified item of content. In some implementations, the custom content 175 can include overlay formatting information and an identifier of a “base” content item to be modified. In some implementations, the custom content 175 can be created at a client device 120 using the content modifier 190, and transmitted to and stored by the media server 105. The custom content 175 can be accessed by other user profiles 160, for example, in one or more inbox messages (sometimes referred to as “direct message(s)”), one or more content playlists 165, one or more chats 170, or other communications between users via the media server 105.

It will be appreciated that the media server 105, in communication with the client devices 120, can perform various functionalities relating to creating and sharing media content, as described herein. In general, the functionalities of the media server 105 can be accessed via the application 180 executing on the client device 120, as described herein. The application 180 can be used to access content, save content in association with a user profile 160, and share content with other user profiles 165. Some example user interfaces presented by the application 180 are shown in FIGS. 2A-2K. Referring briefly now to FIG. 2A, depicted is an example “home” screen, which is accessible to a user when the user accesses (e.g., logs into, etc.) the media server 105 using a corresponding user profile 160.

The user interface depicted in FIG. 2A includes various user interface elements, such as the profile avatar 202, which is a photo that identifies the user in the user profile 160. The user interface shown in FIG. 2A also includes actionable objects, such as an actionable object 204 that accesses a user interface for messaging (including direct messages and/or “side chats”), and the actionable object 206 that accesses a user interface that allows the user to modify settings for the application 180. In addition, the home screen for a user profile 160 can include a designated content playlist 165 in the user interface elements 208, which show a series of previews (e.g., five previews for five content items, as shown) for each content item in the designated playlist 165. The content playlist 165 shown on the home screen can be a “top 5” playlist created by the user. In addition, the selectable object 210 directs the application 180 to display the “junk drawer” 212, which is a collection of content items (or content playlists 165) that the user has saved to their user profile 160 for later consumption, sharing, or other use. Individual content items can be viewed by interacting with the preview thumbnail image corresponding to that content item. A user can access a screen to add content by selecting the actionable object 214.

In an example embodiment, the bottom of the user interface shown in FIG. 2, there are five buttons, which can allow the user to view different user interfaces in the application 180. From left to right, the buttons allow the user to view the home screen, a notifications and activity screen, a “now playing” screen, a browse screen, and a “timepicker” screen, which allows a user to request a dynamically generated content playlist 165 from the media server 105. The activity screen is shown in FIG. 2B. Referring now to FIG. 2B, shown is the notifications and activity screen, which displays various activities performed by other user profiles 160 associated with the user profile 160 accessing the activity screen. As shown, the event 215 indicates that another user has “followed you back,” indicating an association between the user profile 160 and the user profile 160 of the user identified in the event 215. In addition, other users that are identified in the user profile 160 (e.g., as followed, as followers, as friends, other associations, etc.) can appear in the activity screen based on interactions performed by those users with the media server 105. For example, if a user creates a new content playlist 165, that activity may appear in the activity screen for other users associated with that user. Similarly, if another user “likes” or interacts with a post made by the user profile 160 accessing the activity screen, that activity may appear, for example, as the event 216. The information in the activity screen can be private to a user profile 160, and not displayed to other users of the media server 105.

The “now playing” screen is shown in FIG. 2C. Referring briefly now to FIG. 2C, depicted is a “now showing” screen, which can enable a user accessing the media server 105 using a user profile 160 to navigate through a content playlist 165. For example, a user may view one or more content items in a content playlist 165 in the order designated in the content playlist 165. Selectable previews of the content items in the content playlist 165 are shown in the user interface elements 218, and the user profile 160 that created the content playlist 165 is shown in the name field 220 below the displayed content item 222. Using the actionable objects 224, 226A, 228, and 230, the user accessing the content playlist 165 can follow the user that created the content playlist 165, “like” the content item currently being shown, add the content item currently being shown to the user's junk drawer 212, and expand or collapse the “reel,” or preview of the content playlist 165. The region below the content items in the content playlist 165 is the subscreen region 232.

When interacted with in a particular way (e.g., a press-and-hold interaction), the like button 226A may overlay the like interface 226B, which can allow the user to provide additional interactions with an item of content. For example, the like interface 226B can include additional functionality, such as a “ninja like,” which indicates that the user profile 160 likes the content item in the content playlist 165, but does not publicly reveal that the user profile 160 liked the content item. This can allow the number of “likes” associated with an item of content to increase without publicly associating a user profile 160 with the item of content. In addition, the like interface 226B can include one or more selectable buttons or links that allows the user profile 160 to interact with the content item using a secondary account associated with the user profile 160.

As shown, the subscreen region 232 can display various subscreens 234A-234E. The subscreen 234A provides information about the content playlist 165, and can display any ongoing chats 170 associated with the content playlist 165. The interface 234B is an implementation of the content modifier 190 (sometimes referred to herein as the “meme maker”). The interface 234C is a subscreen that displays time-based reactions provided by other user profiles 160 that have viewed the content items in the content playlist 165. The subscreen 234D shows user profiles 160 that are associated with (e.g., following) the content playlist 165. The subscreen 234E shows a set of related content playlists 165 associated with the content playlist 165 displayed at 218.

The “browse” screen is shown in FIG. 2D. Referring briefly now to FIG. 2D, depicted is the “browse” screen, which displays new or recently posted content playlists 160 or custom content 175 created by users corresponding to the user profiles 160 of the media server 105. As shown in the subscreen 236A, publicly available content playlists 165 created associated with any user profile 160 of the media server 105 is shown. The content playlists 165 in shown in the subscreen 236A can be shown in chronological order, for example, with the most-recently created content playlists 165 shown at the top of the subscreen 236A. However, it should be understood that the content playlists 165 may be displayed in a variety of different orders, according to different ranking algorithms for content. The subscreen 236B can be specific to the user profile 160 accessing the media server 105 and displaying the browse screen. The subscreen 236B can show content playlists 165 created by users with which the present user profile 160 is associated (e.g., followed, friends, etc.). Like in the subscreen 236A, the content playlists 165 shown in the subscreen 236B can display a name of the user that created the content playlist 165, and can display the content playlists 165 in chronological order.

Screens to add content are shown in FIG. 2E. As shown in FIG. 2E, when actuated, the “Add Content” subscreen on the home screen causes the application 180 to display the subscreen 238A. The subscreen 238A includes a field where a user can enter, or paste, a URI corresponding to a content item. The “Paste+Go” button can automatically enter a URI copied into the clipboard of the client device 220, and attempt to import the content pointed to at the URI. As described herein above, the application 180 can transmit a request to import the identified content item at the URI to the media server 105. Once entered, the application 180 can access the content pointed to by the URI, and can present a preview of the content (and any other associated metadata, such as content duration, name, publication date, etc.) in the subscreen 238B. The subscreen 238B can include four buttons located at the bottom of the subscreen 238B, which can respectively cause the client device 120 to navigate (e.g., in a web browser, etc.) to a source of the content item, transmit a request to save the content to the user profile 160, transmit a request to add the content to a content playlist 165 (e.g., a public content playlist 165 of the user profile 160, etc.), or share the content with other users of the media server 105 (e.g., in one or more messages or chats 170, etc.). Other functionalities of the application 180 and the media server 105 are described in greater detail in the following sections.

### B. Calculating Playback Times for Content Playlists

As briefly explained above, a user can import content to the media server 105 using the “Add Content” feature of the application 180. When adding content to the media server 105, the media server 105 can identify metadata for the content, which can be used when constructing content playlists 165. This metadata can include, for example, content name, content source, the publication date of the content, a publisher of the content, a creator of the content, a duration of the content (e.g., in the case of video, audio, or other temporal content, etc.), or a user-designated segment of the content, among others. This content metadata can be taken into account, for example, when assembling content items into a content playlist 165 for seamless playback on client devices 120.

The content playlists 165 can be displayed in the application 180, such that each content item in the content playlist 165 is displayed for a predetermined amount of time. This predetermined amount of time may vary depending on the type of content item. For example, short videos having a length below a predetermined threshold may be played a number of times until the video has been played for a predetermined time period. Animated images, such as graphical interface format (GIF) images, animated portable network graphic (APNG) images, or WebP images, among others, may similarly be displayed through multiple animation cycles if the duration of the animation falls below a threshold. The number of animations, and in some implementations, the total display duration, can be stored in association with the content item in content playlist 165. When the application 180 accesses the content playlist 165, the number of animations or the total display duration can indicate to the application 180 how long to display the item of content before seamlessly transitioning (e.g., absent user interaction, etc.) to the next item of content in the list 165.

For videos and animated images, the display duration can be inferred/determined in part from the content metadata (e.g., a duration of the video, a duration of an animation, a duration of an audio segment or song, etc.). However, for other content formats, such as social media posts, static images, or text-based content, the media server 105 can use the duration determiner 130 determine a duration for the content. The duration determiner 130 can determine the duration of a content item based on content density. For example, if the content is text-based content (e.g., an article, a news headline, etc.), the duration that the content is displayed in the content playlist 165 can be proportional to the amount of text in the content item. In some implementations, the duration determiner 130 can perform semantic analysis on text content (e.g., using a trained semantic analysis model) to determine a complexity of the text content. The duration associated with the item of content can be determined as proportional to the complexity of the text content. In some implementations, the duration determiner 130 can select a predetermined duration for each item of content.

The duration determiner 130 can determine a duration for image-based content, for example, by providing the image as input to an artificial intelligence model (e.g., machine learning models, convolutional neural networks, decision trees, ruled-based lookup table, etc.) that can accept an image as input and provide an estimated duration as an output. The artificial intelligence models can be trained on images that are maintained by the media server 105 and accessed by the users of the media server 105. When users of the media server 105 access the images, the amount of time that the user observes the image can be stored in association with the image. These durations can be aggregated and normalized (e.g., and constrained within predetermined boundaries, etc.), and assigned to the images as a ground-truth value. Using back-propagation or other supervised learning techniques, the artificial intelligence models can be trained based on the training images and the ground-truth data. In some implementations, the ground-truth data can be assigned to the images as a duration value, and the artificial intelligence model can be used to assign a duration to any new images that are added to the media server 105 by a user using the artificial intelligence model.

The duration determiner 130 can determine a duration for social media posts (e.g., Twitter posts, Facebook posts, Instagram posts, TikTok posts, etc.) using similar processes. However, because social media posts can include combinations of content modalities (e.g., videos and text, images and text, audio and text, etc.), the duration determiner 130 may determine a duration for the social media content by estimating a duration for each content type in the social media post individually (e.g., video duration, text size or complexity, audio duration, etc.), and performing a MAX operation to estimate the total time to display the item of content. In some implementations, other operations may be performed. For example, the duration determiner 130 may sum the total duration of each content type to determine the display duration of the social media content. In some implementations, a user can modify the display duration for an item of content when creating a content playlist 165. For example, upon estimating a duration for an item of content, the estimated duration can be displayed to the user. The user can then modify this value according to their preference, and transmit the modified value to the media server 105 to store in association with the content playlist 165.

The content playlists 165 can then be displayed in the application 180 according to the durations associated with each content item in the playlist. The content items in the content playlist 165 can be provided to a client device 120 that requests the content playlist 165 from the media server 105. In some implementations, one or more of the content items in the content playlist 165 may be maintained in other content sources. In such implementations, the media server 105 can transmit a URI that identifies a network location of the content item, and any associated metadata (e.g., the duration, etc.), to the requesting client device 120, which can then fetch the content for display from the external content source via the network 110. The application 180 can therefore display the content items in the content playlist 165, which may be from multiple different sources, seamlessly and without interruption. When the display duration for a content item in a content playlist 165 is complete, the next item of content in the content playlist 165 can be displayed.

In some implementations, to seamlessly display content of different formats in the application 180 at the client device 120, the application 180 can instantiate (and remove) different player applications, such as video players, audio players, image containers, or other templates that display content in one or more user interfaces. An example user interface that show content from a content playlist 165 being displayed is shown in FIG. 2C. In some implementations, the duration of a content item being displayed as part of a content playlist 165 can be shortened, for example, in response to a user interaction with a content item. For example, the application 180 can detect when a user advances to a later timestamp in video or audio content, and shorten the display duration accordingly. In some implementations, the application 180 can detect when an item of video or audio content is complete based on a signal received from a video or audio player instantiated in the application 180. Likewise, in some implementations, the user may advance to another item of content in the content playlist 165 in response to an interaction.

### C. Tracking and Annotating Chat Interfaces for Multiple Users

The systems and methods of this technical solution can provide techniques that allow users to associate reactions or chat messages with content based on relative timestamps. As described herein above, content playlists 165 can include contents that are displayed for predetermined durations. As the content is displayed, users can transmit messages that include chat messages (e.g., as part of the chats 170, etc.) and/or reaction messages (e.g., reaction emojis, reaction images, etc.), and also identify a relative timestamp in the displayed content item. The media server 105 can use this timestamp to associate the reaction image or chat message with the content item such that it may be displayed concurrently/aligned/synchronized with the corresponding content item at the relative timestamp. The media server 105 can implement and manage the various chat operations described herein using the chat manager 135.

An example of reaction emojis being displayed with content are shown in FIG. 2F. As shown in FIG. 2F, the application 180 is in the “Now Playing” screen, and has navigated to the “Reactions” subscreen. In the subscreen area, as shown, there are multiple reaction emojis. A user viewing the content in the application 180 can send their own reaction emojis into the reaction chat 170 by interacting with one or more of the emoji buttons on the left-hand and right-hand regions in the subscreen. Each of the reaction emojis are associated with a timestamp, which may be shown in the reaction chat subscreen. In addition, reaction messages may appear to other users with an avatar 202 or name of the user profile 160 that was used to provide the reaction message. As described herein, when other users access the item of media content in the content playlist 165, and are authorized to view the reaction images from one or more other users (e.g., invited to a group, follows the other users, is friends with the other users, etc.), the reaction messages can appear in the “Reactions” subscreen at the same relative time (e.g., offset in the content item from when the content item was first displayed, etc.) that the user provided the reaction message. The chat manager 135 can receive the reaction messages from the client devices 120, and store the reaction messages in association with the item of content in the database 115 as part of the chats 170.

In addition, each of the reaction chats 170 can be stored in association with a respective group of user profiles 160 that can view and contribute to the respective chat 170. As shown above the reaction chat subscreen in FIG. 2F, the user can select from a number of selectable user interface elements that each represents a user profile 160 or group. Using the “+” button, a user of the application 180 can create a new group of user profiles 160 with which to engage in a reaction chat 170 for an item of content. In some implementations, the reaction chats 170 can be associated with one or more playlists 165 of content, such that the reaction messages in the reaction chat 170 appear at relative timestamps throughout the content playlist 165, rather than just on the reactions subscreen for the associated item of content. Likewise, in some implementations, the reaction chats 170 can be associated with just an item of content, such that when that item of content is accessed from multiple different content playlists 165, the same reaction chat 170 is shown for that item of content (e.g., according to the groups that the user profile 160 is associated with).

The user may also provide reactions to an item of content publicly by selecting the “world” option from the groups of reaction chat user profiles 160. In some implementations, the user may send only one reaction message at a time (e.g., a single emoji, etc.). However, in some implementations, the user may use the user interface to transmit multiple reactions in a single reaction message (e.g., two emojis associated with a single timestamp, which are displayed at the same time, etc.). In some implementations, the reaction emojis available for selection by a user can be predetermined. The reactions provided by the users of the media server 105 can be utilized in further analysis (as described in greater detail in Section E) to infer sentiments in items of content or portions of items of content.

In some implementations, the user can identify one or more portions (e.g., coordinates, etc.) of the content item (e.g., when displayed in the playback portion 222 of FIG. 2C) to assign a reaction emoji, in addition to a temporal offset. In such implementations, when other users view the item of content, the reaction emoji, image, or message may overlay the content item at the coordinates specified by the user that provided the reaction message. Users viewing a content item may use buttons or other actionable objects in the user interface of the application 180 to hide or view different types (e.g., emojis, images, animated reaction images, text-based messages, etc.) of reaction chats or other chats 170 as described herein. This allows a user to view content without viewing any reactions or chats 170 according to their preferences. In addition, a user can add other user profiles 160 to a reaction chat group by sending a corresponding request to the chat manager 135, which can then associate each designated user profiles 160 with the chat 170, such that the added users can view the reactions when viewing the content item.

In addition to implementing reactions are part of the chats 170, users of the media server 105 can engage in “side chats 170,” which can be chat rooms or chat threads between a user-defined group of users of the media server 105. Similar to the reaction chats, the side chats 170 can persist with content items, and in some implementations, may be similarly timestamped such that messages (e.g., text messages, multimedia messages including video, audio, or images, etc.) appear at offsets in the content at which the message was sent to the side chat. For example, if a user sends a side chat 170 message at 30 seconds into playing a video content item, the side chat 170 message can appear in the side chat 170 subscreen to other users when they reach the 30 second offset into viewing the video content item. Content items or content playlists 165 can be shared by a user in a side chat 170. In some implementations, multiple side chats 170 (e.g., for different groups of user profiles 160) can be associated with a single item of content, or a content playlist 165. The side chats 170 can be updated by users that transmit messages to the media server 105 using the user interfaces presented in the application 180. Similar to the reaction chats 170, users can select the groups of user profiles 160 with which to engage in side chats 170 by selecting buttons in the user interfaces that correspond to each group. In some implementations, there can be a public chat 170 associated with a content item that is not limited to a certain group of user profiles 160.

D. Managing Messages and Inboxes that Present Reels of Content

In addition to providing chat interfaces that are integrated content items, the media server 105 can manage and communicate messages between users of the content sharing platform using the inbox manager 140. The inbox manager 140 can enable users to create and transmit messages to other users of the media server 105, using the application 180 executing on the client device 120. For example, as described herein above, using an actionable object 204 on the home screen, a user can access an inbox that is associated with their user profile 160. The user profile 160 can store the messages in the inbox, including any messages that the user has received or drafted to other users of the media server 105. In general, the messages that are communicated to users via the inbox interface can include any type of content, such as text content, content items maintained at the media server 105, or content playlists 165 that are created or shared by other users of the media server 105.

An example inbox interface is shown in FIG. 2G. As shown in FIG. 2A, when a user interacts with the message button 204 on their home screen in the application 180, the application 180 can navigate to or otherwise display the inbox interface. For example, the application 180 can transmit a request to the inbox manager 140 at the media server 105, which can return a list of messages that are transmitted to, or sent by (e.g., if looking at the user's sent box, etc.), the user profile 160 accessing the media server 105 using the application 180. The request can include an identifier of the user profile 160. In response to the request, the inbox manager 140 can transmit a (e.g., chronological) list of messages received by the user for display in the application 180. In some implementations, a user may transmit a search query to the inbox manager 140 in a search request for one or more messages. The search query can include, for example, one or more keywords or identifiers of content items or content playlists 165. The inbox manager 140 can receive the search query, and identify inbox messages that have attributes that match one or more of the search query terms. The inbox manager 140 can transmit a list of the identified inbox messages to the requesting application 180 for display.

As shown in FIG. 2G, a user may receive various chats 170 or messages from multiple users (e.g., a group of users) or a single user, in various threads. Threads are chronological lists of related messages that are stored together in the database 115. As shown, the inbox can sort the messages received from the inbox manager 140 based on the sender of a message in a thread, or the group associated with the thread, in chronological order, with more recent messages appearing at the top of the user's inbox. Each of the threads in the inbox can be associated with a composite reel, or composite content playlist 165, that includes all of the content shared in a particular thread. In some implementations, the composite reel (e.g., a composite playlist 165, etc.) can represent the entire inbox, and be inclusive of all content sent to the user in the inbox. The inbox manager 140 can generate and update these composite playlists 165 as new messages are sent to a user. For example, each time a new item of content or a new playlist 165 is provided to a thread with which the user is associated, the inbox manager 140 can append/prepend/incorporate the content or the playlist 165 to the composite playlist 165 associated with that thread. Likewise, the inbox manager 140 can update or append any received content to the composite playlist 165 associated with the user's inbox, for example, in chronological order based on when the content is received. The inbox manager 140 can flag one or more messages directed to a user profile 160 as unread, which may indicate to a user that new content in a thread or group chat 170 is available to view.

A user can use the inbox interface to draft messages to other users (e.g., associated with respective user profiles 160) of the media server 105. To do so, the user can access a corresponding user interface in the application 180. The user interface can include fields that allow a user to specify one or more recipients of the message (e.g., or a respective group or thread to which the message is directed, etc.), and message contents. The user may also specify one or more content playlists 165 constructed from content in the user's “junk drawer 212,” or personal repository as described herein, or individual items of content that the user has otherwise accessed via the media server 105. For example, the user can specify one or more identifiers of an item of content (e.g., stored in the database 115, etc.) or identifiers of content playlists 165, to include in the message. The application 180 can include one or more fields that allow a user to enter a text-based message in addition to any content in the message.

Once the user has provided all of the information and interacted with a “send” button, the application 180 can transmit the message to the inbox manager 140. The inbox manager 140 receive the message, and identify the recipient user profiles 160 specified by the user. The inbox manager 140 can store an association between the contents of the message (e.g., text-based message, content items, content playlists 165, etc.) and the user profiles 160, such that when the users corresponding to the recipient user profiles 160 can access the message in their respective inboxes via the application 180. These messages can be stored as part of the chats 170 in the database 115. In some implementations, users can interact with various buttons or user interface elements to block, hide, report, or delete comments in a thread or chat 170 by sending a corresponding request to the inbox manager 140.

E. Tracking and Tagging Content with Predefined Sentiments

The systems and methods described herein can maintain content items and content playlists 165 in the database 115. The content tracker 145 and the sentiment determiner 150 can identify sentiments for portions of content that are displayed to users via the application 180. For example, the content tracker 145 can track analytical data for all content items that are displayed to users via the functionality of the media server 105. The content tracker 145 can detect when content items are served (e.g., via identifiers of content items that are accessed by the client devices 120, etc.), and can store analytical data in association with the content items in the database 115. The content tracker 145 can perform similar analytical processes for each of the content playlists 165. The content tracker 145 can track various attributes of content items and the content playlists 165, such as number of views, number of shares, number of unique shares, a number of times a content item has been included in a playlist 165, a number of likes, a number of ninja-likes (e.g., anonymous likes, etc.), or a number of times a content item is included in a “top 5” content playlist 165, among others. The content tracker 145 can also maintain lists of content playlists 165 in which each content item appears.

These analytical values can be used to identify content items that are popular or viral. For example, content items or content playlists 165 that have a predetermined number of views that is greater than a threshold number, or greater than other content items in a predetermined period of time (e.g., the last day, the last week, the last month, the last year, etc.) can be considered “popular” content items or content playlists 165. The content tracker 145 may recommend content items to users of the media server 105 that are the most popular over a predetermined period of time. In some implementations, the content tracker 145 can identify content items that are popular among the user profiles 160 that are identified as friends, followers, or followees of a user (e.g., in the friend graph as described herein, etc.). For example, the content tracker 145 can track interactions (e.g., views, likes, shares, etc.) of each user profile 160, and identify/recommend popular content items among groups of users that share friend associations. The content items that are popular amongst friend groups or friend associations can be provided to the application 180 as one or more recommendations, with an indication that the recommend content items or content playlists 165 are popular amongst a user's friends.

The content tracker 145 may also recommend content items or content playlists 165 based on sentiment associations, which can be determined by the sentiment determiner 150. The sentiment determiner 150 can determine and associate sentiments for items of content, or content playlists 165, based on input provided from users of the media server 105. An example user interface of the application 180 that allows users to associate sentiments with content items or content playlists 165 is shown in FIG. 2H. As shown in FIG. 2H, the subscreen 240A can be selected in the “Play Now” screen while viewing one or more content items or content playlists 165. The subscreen 240A includes a number of predefined sentiments, which can be provided by the sentiment determiner 150. As the user watches the content, the user may provide one or more sentiments by interacting with each of the tags shown in the subscreen 240A. In some implementations, a user can create a custom tag by interacting with the “Add” button, which can cause the application 180 to present an interface that accepts user input to specify a customized tag. Any custom tags can be transmitted to the sentiment determiner 150, which can associate the custom tags with the content item (or the content playlist 165) being viewed by the user at that particular moment. Users can also select from the predefined sentiments provided by the sentiment determiner 150, which may be ranked or ordered based on their popularity with respect to the content item being viewed. When a user interacts with a predetermined tag, the application 180 can transmit a message to the sentiment determiner 150, which indicates that the user has associated the content item being viewed with the respective tag.

In some implementations, the sentiment determiner 150 can associate each tag with the content item according to the relative time within the content item that the tag was selected by the user. This can allow a user to designate different portions of a single content item (e.g., a video content item, and audio content item, etc.) with different sentiments. The sentiment determiner 150 can receive these sentiments and the relative timestamps provided by the application 180, and can store an association between the content item and the selected tag. The sentiment determiner 150 can track the number of time each tag has been associated with an item of content across the users of the media server 105. In some implementations, the sentiment determiner 150 can identify particular sentiments provided by a user profile 160, for example, as an attribute of the user profile 160. For example, the sentiment determiner 150 can determine that a user corresponding to a user profile 160 frequently associates a select set of tags with certain types of content (e.g., a “Happy” tag with funny content, etc.). These identified relationships or trends can be stored in association with the respective user profile 160, and used by the content tracker 145 to recommend similar content that the user is also likely to be interested in or to interact with. In addition, the content tracker 145 may recommend or present advertisements related to a determined sentiment or tag at the relative offset in the content item to which the sentiment or tag is assigned.

The sentiment determiner 150 may also infer sentiments by analyzing the chats 170 associated with a particular content item or content playlist 165. As described herein above, the reaction chats 170 can allows users of the media server 105 to include time-based reaction emojis with content items. The sentiment determiner 150 can parse these reaction chats 170 to identify trends in types of emojis at various relative timestamps corresponding to the content item, and infer any related trends. For example, if the sentiment determiner 150 identifies that across many users of the media server 105, a “laughing” emoji was provided as a reaction to a particular content item at an offset of 30 seconds. This can indicate to the sentiment determiner 150 that a funny moment occurs within the content item at the 30 second offset, and the sentiment determiner 150 can store an association between the content item with a “funny” tag or another related tag. These tags can then be used, for example, when recommending content to users that tend to interact with content designated as “funny.” In some implementations, the frequency or number of reactions provided by a particular user can be normalized based on the frequency with which a user provides reactions to content, and the frequency with which a user selects certain types of reactions. For example, reactions of a user that reacts with a “laughing” emoji to almost every item of content viewed by that user may be given less weight than reactions provided by a user that rarely reacts to content items. In some implementations, certain user profiles 160 may be assigned to categories according to the frequency of types of reactions provided content items.

Once sentiments are determined for items of content, the sentiments themselves may be presented to a user that is browsing content, for example, in their personal content repository 212. An example of such presentation is shown in the subscreen 240B. As shown in the subscreen 240B, items of content in a user's personal repository (“junk drawer 212”) are overlaid with semi-transparent reaction emojis that correspond to the sentiments determined for that content item by the sentiment determiner 150. In some implementations, the user can sort or search through their personal repository 212 according to requested sentiment. For example, a user can request content items in their personal repository 212 that are associated with a “happy sentiment,” and the application 180 will display those content items in the subscreen 240B in response to the request.

In addition to tracking interactions and sentiments, the content tracker 145 can track which content playlists 165 that include a particular item of content. When viewing an item of content, a user can request a list of other content playlists 165 that include that content item, for example, in an effort to view new or related content. An example user interface showing a content item that appears in multiple content playlists 165 is shown in FIG. 2I. As shown in FIG. 2I, the user has accessed the “In Other Reels” subscreen, which can cause the application 180 to transmit a request to the content tracker 145 for a list of public content playlists 165 (e.g., “top 5” reels, etc.) that include the content item currently being viewed. In some implementations, the request can indicate that the user requests content playlists 165 that are associated with user profiles 160 identified as friends of the user. In response to the request, the content tracker 145 can transmit a list of content playlists 165 to the application 180, with an indication of the location in the content playlist 165 at which the content item appears. This is shown in FIG. 2I as a highlighted outline around the content item in each content playlist 165. If a user interacts with a content playlist 165 in the list, the application 180 can display the content items in the selected content playlist 165 as described herein. In some implementations, the user can include the currently playing content item into one or more of their content playlists 165, such as a “top 5” content playlist 165.

### F. Integrated Content Modification and Publishing

In addition to displaying content items and content playlists 165, the application 180 can include a content modifier 190 (e.g., natively part or integrated into the environment and/or user interface of the application 180), that can be used to modify or create content items by adding text, overlay content, or other content features. The content modifier 190 can be, for example, a “meme maker,” which allows a user to access and modify content, which can be transmitted to the media server 105 can stored as the custom content 175 in association with the user profile 160 of the user. The custom content 175 can then be shared, for example, in one or more messages or chats 170, included in one or more content playlists 165, annotated with reactions, and used in the sentiment analysis and content tracking processes described herein, among other operations of the media server 105.

The functionality of the content modifier 190 can be accessed, for example, in the “Now Playing” interface of the application 180 by interacting with the “Meme Maker” subscreen 234B. Any content that can be displayed by the application 180 can be used in connection with the content modifier 190. This can include, for example, social media posts, videos, audio, images, or text content, among others. An example user interface for the content modifier 190 is shown in FIG. 2J. As shown in FIG. 2J, a user is displaying a video, which is reflected in the content modifier 190 subscreen below the video. The user can press the red screenshot button on the right of the video to cause the application 180 to generate an image of the current frame of the video being displayed. The captured image of the frame of the video can then be displayed in the subscreen while the video continues to play in the “Now Playing” region. The content modifier 190 can capture an image of the frame by taking a screenshot of the screen, and extracting the pixels from the screenshot that correspond to the video currently being played. The content modifier 190 can store these pixels as their own image in the memory of the client device 120 for further modification by the user. The content modifier 190 can also perform the operations described in connection with this section to modify and create any type of content, including modified video content.

The content modifier 190 can then present various options to the user, for example, to add text, prune content, overlay images, overlay other content, insert the captured screenshot or content into a predetermined layout, or other content modification operations. The content modifier 190 can apply one or more filters to the content to modify the pixels of the content according to user input. For example, a user may select an edge detection filter to make edges in the screenshot appear more prominent, or select a grayscale filter to make the screenshot grayscale, or apply a smoothing filter to smooth out detected features in the image, among others operations. It will be appreciated that the functionality of the content modifier 190 is not limited to the previously described filters or operations, and that any type of image modification/creation technique can be applied to the screenshot according to user input. When overlaying text or image content over the content, the user can specify the size, font, and position of the text, including other options such as transparency, a layer on which the overlay content or the screenshot is placed, or other overlay options. Similarly, if the content being modified is video content, the user can specify durations or particular frames on which the filters, overlays, or other modifications will appear.

Once the user has completed the content modification/creation process, the content modifier 190 can flatten each of the layers of the modified content to generate a final item of content, which can be stored as a custom content item 175 in the memory of the client device 120. The user can then select one or more user interface elements to transmit the custom content item 175 to the media server 105, which can store the custom content item 175 in association with the user profile 160 of the user. In some implementations, the generated custom content item 175 can be stored as part of a personal repository (e.g., the “junk drawer 212”) of the user profile 160.

### G. Dynamic Generation of Content Playlists for Users

The systems and methods described herein can recommend content to users by assembling customized content playlists 165 dynamically in response to user requests. These features are implemented by the playlist generator 155 of the media server 105. A user, accessing the media server 105 using a user profile 160, can request a dynamic content playlist 165 from the playlist generator 155 by transmitting a request from the application 180 according to various desired criteria. For example, the criteria can specify a total or maximum duration for the content playlist 165, a source of content for the content playlist 165, a type of content for the content playlist 165, or a desired sentiment or tag(s) for the content playlist 165, among others. In response to the request, the playlist generator 155 can generate a playlist that includes content items that satisfied the indicated criteria.

An example interface that enables a user to request dynamic playlists of content from the playlist generator 155 is shown in FIG. 2K. As shown, when the user selects the “Time Picker” screen from the home menu, the user interface 242 is displayed. It should be understood that the interface 242 is provided as an example interface, and that other user interface elements can be included that allow a user to input various criteria that should be satisfied by the playlist generator 155 when generating the dynamic content playlist 165. As shown, a vertical slider in the middle of the user interface 242A can be used to indicate the requested duration of the dynamic content playlist 165.

When the user moves the vertical slider toward the top of the user interface 242A (e.g., via user input, etc.) and away from the center, the requested duration of the dynamic content playlist 165 increases in magnitude. The upward direction of the slider can be used to indicate that the user requests to view content associated with other users of the media server 105, such as content from playlists 165 of friends of the requesting user. As shown in the user interface 242B, as the user moves the slider upward, the button “Play Social” appears, which when actuated causes the application 180 to request a dynamic content playlist 165 from the playlist generator 155 generated from content associated with the user's friends. Likewise, when the user moves the vertical slider downward from the center, the requested duration of the dynamic content playlist 165 also increases in magnitude. However, the downward direction indicates that the user is requesting a dynamic content playlist 165 composed of content items that are in a personal repository of the user (e.g., a junk drawer 212, etc.).

Upon receiving the request, the playlist generator 155 can identify the requested duration and the requested source for the dynamic content playlist 165, and identify a set of content items from the requested source that meet the criteria specified by the user. In some implementations, the playlist generator 155 can identify a predetermined number of content items (e.g., at least five content items, etc.) to include in the dynamic content playlist 165. As described herein, each content item (or identifier of a content item) is stored in the database 115 in association with a display duration, indicating the period of time that the content item can display when included in a content playlist 165. The playlist generator 155 can select content items that have a duration that is less than the requested duration for the dynamic content playlist 165. The playlist generator 155 can select content items based on their attributes, for example, based on similarity attributes between content that was previously interacted with by the requesting user (e.g., a like, inclusion in other content playlists 165, etc.). In some implementations, the playlist generator 155 may select content items that the user has not yet viewed, thereby constructing a dynamic playlist 165 of unviewed content items.

The playlist generator 155 can select content items that are generally popular, as indicated in the analytical data generated by the content tracker 145. For example, the playlist generator 155 can include one or more viral or most-liked content items in the dynamic content playlist 165. The playlist generator 155 may also include content items that are similar to other content items with which the user has previously engaged (e.g., interacted with, liked, ninja-liked, incorporated in a content playlist 165, etc.). For example, content items that are created by the same creator as a content item liked by a user may be included in the dynamic content playlist 165. Other attributes, such as emotional sentiments identified by the sentiment determiner 150 for content items, may be used as content selection criteria when generating the dynamic content playlist 155. For example, if historic interactions indicate that the user frequently interacts with content items that are tagged as “funny,” the playlist generator 155 may be more likely to select content items that are also tagged as “funny,” and also meet other selection criteria. The playlist generator 155 can utilize weight values assigned to each of the selection criteria for including content items in the dynamic content playlist 165. In some implementations, the playlist generator 155 can select content items for inclusion in the dynamic content playlist 165 iteratively, until the specified duration for the content playlist 165 has been satisfied.

Once the playlist generator 155 has generated the dynamic content playlist 165 by selecting content items according to the above-described criteria, the playlist generator 155 can transmit the generated content playlist 165 for display in the “Now Playing” tab of the application 180. In some implementations, the playlist generator 155 can store an association between the generated content playlist 165 and the user profile 160, such that the user can save the generated content playlist 165 or share it with other users of the media server 105. In some implementations, the playlist generator 155 may generate several content playlists 165 that meet the specified criteria, and the user can select (e.g., via user input) the desired content playlist 165 to view. The other content playlists 165 can be similarly be stored in association with the user profile 160 for later viewing. In some implementations, upon observing the generated content playlists 165, the user can modify the selection criteria for the playlist generator 155 to change the generated content playlists 165. For example, if the user does not intend to view any or some portion of the generated playlists 165, the user can change the criteria to correspond to particular tags, locations, content sources, or other selection criteria. The playlist generator 155 can then generate another set of dynamic content playlists 165 according to the new criteria, and send the new results to the user, as described above.

### H. Computing and Network Environment

Having now discussed some specific implementations of the various aspects of this technical solution, it may be helpful to describe aspects of the operating environment as well as associated system components (e.g., hardware elements) in connection with the methods and systems described herein. Referring to FIG. 3A, an embodiment of a network environment is depicted. In brief overview, the network environment includes one or more clients 302a-302n (also generally referred to as local machine(s) 302, client(s) 302, client node(s) 302, client machine(s) 302, client computer(s) 302, client device(s) 302, endpoint(s) 302, or endpoint node(s) 302) in communication with one or more agents 303a-303n and one or more servers 306a-306n (also generally referred to as server(s) 306, node 306, or remote machine(s) 306) via one or more networks 304. In some embodiments, a client 302 has the capacity to function as both a client node seeking access to resources provided by a server and as a server providing access to hosted resources for other clients 302a-302n.

Although FIG. 3A shows a network 304 between the clients 302 and the servers 306, the clients 302 and the servers 306 may be on the same network 304. In some embodiments, there are multiple networks 304 between the clients 302 and the servers 306. In one of these embodiments, a network 304′ (not shown) may be a private network and a network 304 may be a public network. In another of these embodiments, a network 304 may be a private network and a network 304′ a public network. In still another of these embodiments, networks 304 and 304′ may both be private networks.

The network 304 may be connected via wired or wireless links. Wired links may include Digital Subscriber Line (DSL), coaxial cable lines, or optical fiber lines. The wireless links may include BLUETOOTH, Wi-Fi, Worldwide Interoperability for Microwave Access (WiMAX), an infrared channel or satellite band. The wireless links may also include any cellular network standards used to communicate among mobile devices, including standards that qualify as 1G, 2G, 3G, 4G, or 5G. The network standards may qualify as one or more generation of mobile telecommunication standards by fulfilling a specification or standards such as the specifications maintained by International Telecommunication Union. The 3G standards, for example, may correspond to the International Mobile Telecommunications-2000 (IMT-2000) specification, and the 4G standards may correspond to the International Mobile Telecommunications Advanced (IMT-Advanced) specification. Examples of cellular network standards include AMPS, GSM, GPRS, UMTS, LTE, LTE Advanced, Mobile WiMAX, and WiMAX-Advanced. Cellular network standards may use various channel access methods e.g. FDMA, TDMA, CDMA, or SDMA. In some embodiments, different types of data may be transmitted via different links and standards. In other embodiments, the same types of data may be transmitted via different links and standards.

The network 304 may be any type and/or form of network. The geographical scope of the network 304 may vary widely and the network 304 can be a body area network (BAN), a personal area network (PAN), a local-area network (LAN), e.g. Intranet, a metropolitan area network (MAN), a wide area network (WAN), or the Internet. The topology of the network 304 may be of any form and may include, e.g., any of the following: point-to-point, bus, star, ring, mesh, or tree. The network 304 may be an overlay network which is virtual and sits on top of one or more layers of other networks 304′. The network 304 may be of any such network topology as known to those ordinarily skilled in the art capable of supporting the operations described herein. The network 304 may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite may include application layer, transport layer, internet layer (including, e.g., IPv6), or the link layer. The network 304 may be a type of a broadcast network, a telecommunications network, a data communication network, or a computer network.

In some embodiments, the system may include multiple, logically-grouped servers 306. In one of these embodiments, the logical group of servers may be referred to as a server farm (not shown) or a machine farm. In another of these embodiments, the servers 306 may be geographically dispersed. In other embodiments, a machine farm may be administered as a single entity. In still other embodiments, the machine farm includes a plurality of machine farms. The servers 306 within each machine farm can be heterogeneous-one or more of the servers 306 or machines 306 can operate according to one type of operating system platform (e.g., WINDOWS NT, manufactured by Microsoft Corp. of Redmond, Washington), while one or more of the other servers 306 can operate on according to another type of operating system platform (e.g., Unix, Linux, or Mac OS X).

In one embodiment, servers 306 in the machine farm may be stored in high-density rack systems, along with associated storage systems, and located in an enterprise data center. In this embodiment, consolidating the servers 306 in this way may improve system manageability, data security, the physical security of the system, and system performance by locating servers 306 and high performance storage systems on localized high performance networks. Centralizing the servers 306 and storage systems and coupling them with advanced system management tools allows more efficient use of server resources.

The servers 306 of each machine farm do not need to be physically proximate to another server 306 in the same machine farm. Thus, the group of servers 306 logically grouped as a machine farm may be interconnected using a wide-area network (WAN) connection or a metropolitan-area network (MAN) connection. For example, a machine farm may include servers 306 physically located in different continents or different regions of a continent, country, state, city, campus, or room. Data transmission speeds between servers 306 in the machine farm can be increased if the servers 306 are connected using a local-area network (LAN) connection or some form of direct connection. Additionally, a heterogeneous machine farm may include one or more servers 306 operating according to a type of operating system, while one or more other servers 306 execute one or more types of hypervisors rather than operating systems. In these embodiments, hypervisors may be used to emulate virtual hardware, partition physical hardware, virtualize physical hardware, and execute virtual machines that provide access to computing environments, allowing multiple operating systems to run concurrently on a host computer. Native hypervisors may run directly on the host computer. Hypervisors may include VMware ESX/ESXi, manufactured by VMWare, Inc., of Palo Alto, California; the Xen hypervisor, an open source product whose development is overseen by Citrix Systems, Inc.; the HYPER-V hypervisors provided by Microsoft or others. Hosted hypervisors may run within an operating system on a second software level. Examples of hosted hypervisors may include VMware Workstation and VIRTUALBOX.

Management of the machine farm may be de-centralized. For example, one or more servers 306 may comprise components, subsystems and modules to support one or more management services for the machine farm. In one of these embodiments, one or more servers 306 provide functionality for management of dynamic data, including techniques for handling failover, data replication, and increasing the robustness of the machine farm. Each server 306 may communicate with a persistent store and, in some embodiments, with a dynamic store.

Server 306 may be a file server, application server, web server, proxy server, appliance, network appliance, gateway, gateway server, virtualization server, deployment server, SSL VPN server, or firewall. In one embodiment, the server 306 may be referred to as a remote machine or a node. In another embodiment, a plurality of nodes 290 may be in the path between any two communicating servers.

Referring to FIG. 3B, a cloud computing environment is depicted. A cloud computing environment may provide client 302 with one or more resources provided by a network environment. The cloud computing environment may include one or more clients 302a-302n, in communication with respective agents 303a-303n and with the cloud 308 over one or more networks 304. Clients 302 may include, e.g., thick clients, thin clients, and zero clients. A thick client may provide at least some functionality even when disconnected from the cloud 308 or servers 306. A thin client or a zero client may depend on the connection to the cloud 308 or server 306 to provide functionality. A zero client may depend on the cloud 308 or other networks 304 or servers 306 to retrieve operating system data for the client device. The cloud 308 may include back end platforms, e.g., servers 306, storage, and server farms or data centers.

The cloud 308 may be public, private, or hybrid. Public clouds may include public servers 306 that are maintained by third parties to the clients 302 or the owners of the clients. The servers 306 may be located off-site in remote geographical locations as disclosed above or otherwise. Public clouds may be connected to the servers 306 over a public network. Private clouds may include private servers 306 that are physically maintained by clients 302 or owners of clients. Private clouds may be connected to the servers 306 over a private network 304. Hybrid clouds 308 may include both the private and public networks 304 and servers 306.

The cloud 308 may also include a cloud based delivery, e.g. Software as a Service (Saas) 310, Platform as a Service (PaaS) 312, and Infrastructure as a Service (IaaS) 314. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Washington, RACKSPACE CLOUD provided by Rackspace US, Inc., of San Antonio, Texas, Google Compute Engine provided by Google Inc. of Mountain View, California, or RIGHTSCALE provided by RightScale, Inc., of Santa Barbara, California. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Washington, Google App Engine provided by Google Inc., and HEROKU provided by Heroku, Inc. of San Francisco, California. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, California, or OFFICE 365 provided by Microsoft Corporation. Examples of SaaS may also include data storage providers, e.g. DROPBOX provided by Dropbox, Inc. of San Francisco, California, Microsoft SKYDRIVE provided by Microsoft Corporation, Google Drive provided by Google Inc., or Apple ICLOUD provided by Apple Inc. of Cupertino, California.

Clients 302 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 302 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 302 may access SaaS resources through the use of web-based user interfaces, provided by a web browser (e.g. GOOGLE CHROME, Microsoft INTERNET EXPLORER, or Mozilla Firefox provided by Mozilla Foundation of Mountain View, California). Clients 302 may also access SaaS resources through smartphone or tablet applications, including, e.g., Salesforce Sales Cloud, or Google Drive app. Clients 302 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

The client 302 and server 306 may be deployed as and/or executed on any type and form of computing device, e.g. a computer, network device or appliance capable of communicating on any type and form of network and performing the operations described herein. FIGS. 3C and 3D depict block diagrams of a computing device 300 useful for practicing an embodiment of the client 302 or a server 306. As shown in FIGS. 3C and 3D, each computing device 300 includes a central processing unit 321, and a main memory unit 322. As shown in FIG. 3C, a computing device 300 may include a storage device 328, an installation device 316, a network interface 318, an I/O controller 323, display devices 324a-324n, a keyboard 326 and a pointing device 327, e.g. a mouse. The storage device 328 may include, without limitation, an operating system, software, and media platform 320, which can implement any of the features of the media server 105 described herein below in conjunction with FIG. 1. As shown in FIG. 3D, each computing device 300 may also include additional optional elements, e.g. a memory port 332, a bridge 370, one or more input/output devices 330a-330n (generally referred to using reference numeral 330), and a cache memory 340 in communication with the central processing unit 321.

The central processing unit 321 is any logic circuitry that responds to and processes instructions fetched from the main memory unit 322. In many embodiments, the central processing unit 321 is provided by a microprocessor unit, e.g.: those manufactured by Intel Corporation of Mountain View, California; those manufactured by Motorola Corporation of Schaumburg, Illinois; the ARM processor and TEGRA system on a chip (SoC) manufactured by Nvidia of Santa Clara, California; the POWER7 processor, those manufactured by International Business Machines of White Plains, New York; or those manufactured by Advanced Micro Devices of Sunnyvale, California. The computing device 300 may be based on any of these processors, or any other processor capable of operating as described herein. The central processing unit 321 may utilize instruction level parallelism, thread level parallelism, different levels of cache, and multi-core processors. A multi-core processor may include two or more processing units on a single computing component. Examples of a multi-core processors include the AMD PHENOM IIX2, INTEL CORE 15, INTEL CORE i7, and INTEL CORE i9.

Main memory unit 322 may include one or more memory chips capable of storing data and allowing any storage location to be directly accessed by the microprocessor 321. Main memory unit 322 may be volatile and faster than storage 328 memory. Main memory units 322 may be Dynamic random access memory (DRAM) or any variants, including static random access memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 322 or the storage 328 may be non-volatile; e.g., non-volatile read access memory (NVRAM), flash memory non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The main memory 322 may be based on any of the above described memory chips, or any other available memory chips capable of operating as described herein. In the embodiment shown in FIG. 3C, the processor 321 communicates with main memory 322 via a system bus 350 (described in more detail below). FIG. 3D depicts an embodiment of a computing device 300 in which the processor communicates directly with main memory 322 via a memory port 332. For example, in FIG. 3D the main memory 322 may be DRDRAM.

FIG. 3D depicts an embodiment in which the main processor 321 communicates directly with cache memory 340 via a secondary bus, sometimes referred to as a backside bus. In other embodiments, the main processor 321 communicates with cache memory 340 using the system bus 350. Cache memory 340 typically has a faster response time than main memory 322 and is typically provided by SRAM, BSRAM, or EDRAM. In the embodiment shown in FIG. 3D, the processor 321 communicates with various I/O devices 330 via a local system bus 350. Various buses may be used to connect the central processing unit 321 to any of the I/O devices 330, including a PCI bus, a PCI-X bus, or a PCI-Express bus, or a NuBus. For embodiments in which the I/O device is a video display 324, the processor 321 may use an Advanced Graphics Port (AGP) to communicate with the display 324 or the I/O controller 323 for the display 324. FIG. 3D depicts an embodiment of a computer 300 in which the main processor 321 communicates directly with I/O device 330b or other processors 321′ via HYPERTRANSPORT, RAPIDIO, or INFINIBAND communications technology. FIG. 3D also depicts an embodiment in which local busses and direct communication are mixed: the processor 321 communicates with I/O device 330a using a local interconnect bus while communicating with I/O device 330b directly.

A wide variety of I/O devices 330a-330n may be present in the computing device 300. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers.

Devices 330a-330n may include a combination of multiple input or output devices, including, e.g., Microsoft KINECT, Nintendo Wiimote for the WII, Nintendo WII U GAMEPAD, or Apple IPHONE. Some devices 330a-330n allow gesture recognition inputs through combining some of the inputs and outputs. Some devices 330a-330n provides for facial recognition which may be utilized as an input for different purposes including authentication and other commands. Some devices 330a-330n provides for voice recognition and inputs, including, e.g., Microsoft KINECT, SIRI for IPHONE by Apple, Amazon Alexa, Google Now or Google Voice Search.

Additional devices 330a-330n have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices 330a-330n, display devices 324a-324n or group of devices may be augment reality devices. The I/O devices may be controlled by an I/O controller 323 as shown in FIG. 3C. The I/O controller may control one or more I/O devices, such as, e.g., a keyboard 326 and a pointing device 327, e.g., a mouse or optical pen. Furthermore, an I/O device may also provide storage and/or an installation medium 316 for the computing device 300. In still other embodiments, the computing device 300 may provide USB connections (not shown) to receive handheld USB storage devices. In further embodiments, an I/O device 330 may be a bridge between the system bus 350 and an external communication bus, e.g. a USB bus, a SCSI bus, a FireWire bus, an Ethernet bus, a Gigabit Ethernet bus, a Fibre Channel bus, or a Thunderbolt bus.

In some embodiments, display devices 324a-324n may be connected to I/O controller 323. Display devices may include, e.g., liquid crystal displays (LCD), thin film transistor LCD (TFT-LCD), blue phase LCD, electronic papers (e-ink) displays, flexile displays, light emitting diode displays (LED), digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays. Examples of 3D displays may use, e.g. stereoscopy, polarization filters, active shutters, or autostereoscopic. Display devices 324a-324n may also be a head-mounted display (HMD). In some embodiments, display devices 324a-324n or the corresponding I/O controllers 323 may be controlled through or have hardware support for OPENGL or DIRECTX API or other graphics libraries.

In some embodiments, the computing device 300 may include or connect to multiple display devices 324a-324n, which each may be of the same or different type and/or form. As such, any of the I/O devices 330a-330n and/or the I/O controller 323 may include any type and/or form of suitable hardware, software, or combination of hardware and software to support, enable or provide for the connection and use of multiple display devices 324a-324n by the computing device 300. For example, the computing device 300 may include any type and/or form of video adapter, video card, driver, and/or library to interface, communicate, connect or otherwise use the display devices 324a-324n. In one embodiment, a video adapter may include multiple connectors to interface to multiple display devices 324a-324n. In other embodiments, the computing device 300 may include multiple video adapters, with each video adapter connected to one or more of the display devices 324a-324n. In some embodiments, any portion of the operating system of the computing device 300 may be configured for using multiple displays 324a-324n. In other embodiments, one or more of the display devices 324a-324n may be provided by one or more other computing devices 300a or 300b connected to the computing device 300, via the network 304. In some embodiments software may be designed and constructed to use another computer's display device as a second display device 324a for the computing device 300. For example, in one embodiment, an Apple iPad may connect to a computing device 300 and use the display of the device 300 as an additional display screen that may be used as an extended desktop. One ordinarily skilled in the art will recognize and appreciate the various ways and embodiments that a computing device 300 may be configured to have multiple display devices 324a-324n.

Referring again to FIG. 3C, the computing device 300 may comprise a storage device 328 (e.g. one or more hard disk drives or redundant arrays of independent disks) for storing an operating system or other related software, and for storing application software programs such as any program related to the media platform 320. Examples of storage device 328 include, e.g., hard disk drive (HDD); optical drive including CD drive, DVD drive, or BLU-RAY drive; solid-state drive (SSD); USB flash drive; or any other device suitable for storing data. Some storage devices may include multiple volatile and non-volatile memories, including, e.g., solid state hybrid drives that combine hard disks with solid state cache. Some storage device 328 may be non-volatile, mutable, or read-only. Some storage device 328 may be internal and connect to the computing device 300 via a bus 350. Some storage device 328 may be external and connect to the computing device 300 via an I/O device 330 that provides an external bus. Some storage device 328 may connect to the computing device 300 via the network interface 318 over a network 304, including, e.g., the Remote Disk for MACBOOK AIR by Apple. Some client devices 300 may not require a non-volatile storage device 328 and may be thin clients or zero clients 302. Some storage device 328 may also be used as an installation device 316, and may be suitable for installing software and programs. Additionally, the operating system and the software can be run from a bootable medium, for example, a bootable CD, e.g. KNOPPIX, a bootable CD for GNU/Linux that is available as a GNU/Linux distribution from knoppix.net.

Client device 300 may also install software or application from an application distribution platform. Examples of application distribution platforms include the App Store for iOS provided by Apple, Inc., the Mac App Store provided by Apple, Inc., GOOGLE PLAY for Android OS provided by Google Inc., Chrome Webstore for CHROME OS provided by Google Inc., the Oculus App store provided by Meta, Inc., and Amazon Appstore for Android OS and KINDLE FIRE provided by Amazon.com, Inc. An application distribution platform may facilitate installation of software on a client device 302. An application distribution platform may include a repository of applications on a server 306 or a cloud 308, which the clients 302a-302n may access over a network 304. An application distribution platform may include application developed and provided by various developers. A user of a client device 302 may select, purchase and/or download an application via the application distribution platform.

Furthermore, the computing device 300 may include a network interface 318 to interface to the network 304 through a variety of connections including, but not limited to, standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.13A/b/g/n/ac CDMA, GSM, WiMax and direct asynchronous connections). In one embodiment, the computing device 300 communicates with other computing devices 300′ via any type and/or form of gateway or tunneling protocol e.g. Secure Socket Layer (SSL) or Transport Layer Security (TLS), or the Citrix Gateway Protocol manufactured by Citrix Systems, Inc. of Ft. Lauderdale, Florida. The network interface 318 may comprise a built-in network adapter, network interface card, PCMCIA network card, EXPRESSCARD network card, card bus network adapter, wireless network adapter, USB network adapter, modem or any other device suitable for interfacing the computing device 300 to any type of network capable of communication and performing the operations described herein.

A computing device 300 of the sort depicted in FIGS. 3B and 3C may operate under the control of an operating system, which controls scheduling of tasks and access to system resources. The computing device 300 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 2000, WINDOWS Server 2012, WINDOWS CE, WINDOWS Phone, WINDOWS XP, WINDOWS VISTA, and WINDOWS 7, WINDOWS RT, and WINDOWS 8 all of which are manufactured by Microsoft Corporation of Redmond, Washington; MAC OS and iOS, manufactured by Apple, Inc. of Cupertino, California; and Linux, a freely-available operating system, e.g. Linux Mint distribution (“distro”) or Ubuntu, distributed by Canonical Ltd. of London, United Kingdom; or Unix or other Unix-like derivative operating systems; and Android, designed by Google, of Mountain View, California, among others. Some operating systems, including, e.g., the CHROME OS by Google, may be used on zero clients or thin clients, including, e.g., CHROMEBOOKS.

The computer system 300 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computer system 300 has sufficient processor power and memory capacity to perform the operations described herein. In some embodiments, the computing device 300 may have different processors, operating systems, and input devices consistent with the device. The Samsung GALAXY smartphones, e.g., operate under the control of Android operating system developed by Google, Inc. GALAXY smartphones receive input via a touch interface.

In some embodiments, the computing device 300 is a gaming system. For example, the computer system 300 may comprise a PLAYSTATION 3, a PLAYSTATION 4, PLAYSTATION 5, or PERSONAL PLAYSTATION PORTABLE (PSP), or a PLAYSTATION VITA device manufactured by the Sony Corporation of Tokyo, Japan, a NINTENDO DS, NINTENDO 3DS, NINTENDO WII, NINTENDO WII U, or a NINTENDO SWITCH device manufactured by Nintendo Co., Ltd., of Kyoto, Japan, an XBOX 360, an XBOX ONE, an XBOX ONE S, or an XBOX ONE S device manufactured by the Microsoft Corporation of Redmond, Washington.

In some embodiments, the computing device 300 is a digital audio player such as the Apple IPOD, IPOD Touch, and IPOD NANO lines of devices, manufactured by Apple Computer of Cupertino, California. Some digital audio players may have other functionality, including, e.g., a gaming system or any functionality made available by an application from a digital application distribution platform. For example, the IPOD Touch may access the Apple App Store. In some embodiments, the computing device 300 is a portable media player or digital audio player supporting file formats including, but not limited to, MP3, WAV, M4A/AAC, WMA Protected AAC, AIFF, Audible audiobook, Apple Lossless audio file formats and .mov, .m4v, and .mp4 MPEG-4 (H.264/MPEG-4 AVC) video file formats.

In some embodiments, the computing device 300 is a tablet e.g. the IPAD line of devices by Apple; GALAXY TAB family of devices by Samsung; or KINDLE FIRE, by Amazon.com, Inc. of Seattle, Washington. In other embodiments, the computing device 300 is an eBook reader, e.g. the KINDLE family of devices by Amazon.com, or NOOK family of devices by Barnes & Noble, Inc. of New York City, New York.

In some embodiments, the communications device 302 includes a combination of devices, e.g. a smartphone combined with a digital audio player or portable media player. For example, one of these embodiments is a smartphone, e.g. the IPHONE family of smartphones manufactured by Apple, Inc.; a Samsung GALAXY family of smartphones manufactured by Samsung, Inc.; or a Motorola DROID family of smartphones. In these embodiments, the communications devices 302 are web-enabled and can receive and initiate phone calls. In yet another embodiment, the communications device 302 is a laptop or desktop computer equipped with a web browser and a microphone and speaker system, e.g. a telephony headset. In a another embodiment, the communications device 302 is a virtual reality or augmented reality headset or glasses, e.g. the Oculus QUEST family of virtual reality headsets manufactured by Meta, Inc. In some embodiments, a laptop or desktop computer or VR/AR headset is also equipped with a webcam or other video capture device that enables video chat and video call.

In some embodiments, the status of one or more machines 302, 306 in the network 304 is monitored, generally as part of network management. In one of these embodiments, the status of a machine may include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods described herein.

Implementations of the subject matter and the operations described in this specification can be implemented in digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, e.g., one or more components of computer program instructions, encoded on computer storage medium for execution by, or to control the operation of, data processing apparatus. The program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can include a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The terms “data processing apparatus”, “data processing system”, “media server”, “client device”, “computing platform”, “computing device”, or “device” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor can receive instructions and data from a read-only memory or a random access memory or both. The elements of a computer include a processor for performing actions in accordance with instructions and one or more memory devices for storing instructions and data. Generally, a computer can also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), for example. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), plasma, or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can include any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system such as the gaming system 205 can include clients and servers. For example, the gaming system 205 can include one or more servers in one or more data centers or server farms. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving input from a user interacting with the client device). Data generated at the client device (e.g., a result of an interaction, computation, or any other event or computation) can be received from the client device at the server, and vice-versa.

While this specification contains many specific implementation details, these should not be construed as limitations on the scope of any inventions or of what may be claimed, but rather as descriptions of features specific to particular implementations of the systems and methods described herein. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In some cases, the actions recited in the claims can be performed in a different order and still achieve desirable results. In addition, the processes depicted in the accompanying figures do not necessarily require the particular order shown, or sequential order, to achieve desirable results.

In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. For example, the gaming system 205 could be a single module, a logic device having one or more processing modules, one or more servers, or part of a search engine.

Having now described some illustrative implementations and implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed only in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation, and references to “an implementation,” “some implementations,” “an alternate implementation,” “various implementation,” “one implementation” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. Although the examples and techniques provided may be useful for implementing content sharing platforms, the systems and methods described herein may be applied to other environments. The foregoing implementations are illustrative rather than limiting of the described systems and methods. The scope of the systems and methods described herein may thus be indicated by the appended claims, rather than the foregoing description, and changes that come within the meaning and range of equivalency of the claims are embraced therein.

1. A method of determining playback times for content items presented in playlists, comprising:
identifying, by one or more processors coupled to non-transitory memory, a first content item in a content reel comprising a plurality of content items;
determining, by the one or more processors, that the first content item has an undefined display duration;
calculating, by the one or more processors in response to the first content item having an undefined display duration, a display duration for which the first content item should be displayed when presented in the content reel; and
providing, by the one or more processors, the content reel for display at a client device, such that the first content item is displayed for the display duration.

2. The method of claim 1, wherein the display duration is calculated based at least on at least one of a format of the first content item or a size of the first content item.

3. The method of claim 1, wherein the first content item includes text, and wherein the display duration is calculated based at least on a length of the text or a complexity of the text.

4. The method of claim 3, further comprising determining, by the one or more processors, the complexity of the text included in the first content item using a trained semantic analysis model.

5. The method of claim 1, wherein the first content item comprises an image, and wherein calculating the display duration of the first content item comprises providing, by the one or more processors, the image as input to a trained artificial intelligence model that generates the display duration as output.

6. The method of claim 1, wherein the first content item comprises a first content portion having a first modality and a second content portion having a second modality, and wherein calculating the display duration of the first content item comprises:
determining, by the one or more processors, a first duration value based at least on the first content portion and a second duration value based at least on the second content portion; and
calculating, by the one or more processors, the display duration of the first content item based at least on the first duration value and the second duration value.

7. The method of claim 1, further comprising:
receiving, by the one or more processors, a modification to the display duration of the first content item; and
modifying, by the one or more processors, the display duration of the first content item in the content reel according to the modification.

8. The method of claim 1, wherein the first content item of the content reel comprises an animated image or a video, and the method further comprises determining, by the one or more processors, a number of repetitions for the animated image or the video responsive to a duration of the animated image or the video being below a threshold.

9. The method of claim 1, wherein determining that the first content item has an undefined duration comprises extracting, by the one or more processors, metadata from the first content item.

10. The method of claim 1, wherein identifying the first content item is responsive to receiving a request for the content reel from the client device.

11. A system for determining playback times for content items presented in playlists, comprising:
one or more processors coupled to non-transitory memory, the one or more processors configured to:
identify a first content item in a content reel comprising a plurality of content items;
determine that the first content item has an undefined display duration;
calculate, in response to the first content item having an undefined display duration, a display duration for which the first content item should be displayed when presented in the content reel; and
provide the content reel for display at a client device, such that the first content item is displayed for the display duration.

12. The system of claim 11, wherein the display duration is calculated based at least on at least one of a format of the first content item or a size of the first content item.

13. The system of claim 11, wherein the first content item includes text, wherein the display duration is calculated based at least on a length of the text or a complexity of the text, and wherein the one or more processors are further configured to determine the complexity of the text included in the first content item using a trained semantic analysis model.

14. (canceled)

15. The system of claim 11, wherein the first content item comprises an image, and wherein the one or more processors are further configured to calculate the display duration of the first content item by performing operations comprising providing the image as input to a trained artificial intelligence model that generates the display duration as output.

16. The system of claim 11, wherein the first content item comprises a first content portion having a first modality and a second content portion having a second modality, and wherein the one or more processors are further configured to calculate the display duration of the first content item by performing operations comprising:
determining a first duration value based at least on the first content portion and a second duration value based at least on the second content portion; and
calculating the display duration of the first content item based at least on the first duration value and the second duration value.

17. The system of claim 11, wherein the one or more processors are further configured to:
receive a modification to the display duration of the first content item; and
modify the display duration of the first content item in the content reel according to the modification.

18. The system of claim 11, wherein the first content item of the content reel comprises an animated image or a video, and wherein the one or more processors are further configured to determine a number of repetitions for the animated image or the video responsive to a duration of the animated image or the video being below a threshold.

19. The system of claim 11, wherein the one or more processors are further configured to determine that the first content item has an undefined duration by performing operations comprising extracting metadata from the first content item.

20. The system of claim 11, wherein the one or more processors are further configured to identify the first content item responsive to receiving a request for the content reel from the client device.

21. A method of tracking and providing timestamps for chat feeds corresponding to content playback, comprising:
receiving, by one or more processors coupled to non-transitory memory, a message from a client device that indicates a reaction to a content item of a content reel;
determining, by the one or more processors, a relative timestamp for the reaction to the content item of the content reel displayed at the client device;
storing, by the one or more processors, the relative timestamp in association with an identifier of the reaction and the content reel;
receiving, by the one or more processors, a request for the content reel from a second client device; and
providing, by the one or more processors, the content reel to the second client device for display, such that the reaction is displayed at the second client device according to the relative timestamp.

22-120. (canceled)
